(19) United States
(12) Patent Application Publication
(10) Pub. No.: US 2024/0052591 A1
(43) Pub. Date: Feb. 15, 2024

(54) SCREENING BUCKET

(71) Applicant: SIMEX ENGINEERING S.R.L., San Giovanni in Persiceto (Bologn) (IT)

(72) Inventor: Mirco RISI, San Giovanni in Persiceto (Bologna) (IT)

(21) Appl. No.: 18/267,405

(22) PCT Filed: Dec. 16, 2021
(86) PCT No.: PCT/IB2021/061814

§ 371 Date: Jun. 14, 2023

(30) Foreign Application Priority Data
Dec. 16, 2020 (IT) 102020000031091

(51) Int. Cl. E02F 3/407; B07B 1/15

(52) U.S. Cl. CPC E02F 3/407; B07B 1/15

(57) ABSTRACT

A screening bucket having a box-shaped bucket body defining a loading compartment and an unloading opening is provided. The screening bucket has a screening unit for screening debris material, having at least one screening shaft rotatable about a rotation axis, and at least one pinion, mounted on the screening shaft. A plurality of screening blades connected to the screening shaft extend along a radial direction orthogonal to the rotation axis. Drive and transmission elements generate and transmit rotary motion to the at least one pinion. At least one screening blade of the plurality of screening blades has two screening half-blades connected to the screening shaft. Each screening half-blade is connected to the screening shaft approaching the screening shaft along the radial direction. Each screening half-blade is connected to the screening shaft by a positive mechanical connection that is reversible to allow each screening half-blade to be disconnected from the screening shaft.

### FIELD OF INVENTION

This invention relates to a screening bucket suitable to be applied to machines for handling debris material, particularly earth, such as excavating machines or loading machines, for picking up, crushing, and screening said debris material. This invention is also applicable to Signorelli disintegrating or crushing machines. Therefore, hereinafter when a screening bucket is discussed, a disintegrating bucket or crushing bucket is also intended.

### PRIOR ART

A first known type of screening bucket comprises a basket-shaped structure that forms a lattice wall and defines a loading opening. Screening is performed by loading the debris material into the basket through the loading opening, and rotating the basket about its own rotation axis, so as to eject the debris material contained through the filtering lattice wall. Thus, only debris material that is smaller than the size of the lattice of the lattice wall is ejected from the basket, while debris material that is larger than the size of the lattice remains inside the basket.

For example, such a solution is known from KR101366423.

However, this first type of screening bucket is not adapted to exert high forces on the debris material to be screened, and therefore is not suitable for performing effective crushing of the debris material.

A second known type of screening bucket, also suitable for crushing debris material, comprises a box-shaped bucket body defining a loading chamber for picking up debris material into the screening bucket, and a discharge opening for discharging the screened debris material.

Further, these screening buckets comprise a screening unit, which generally comprises a plurality of pinions that may be moved in rotation by feed and drive means.

The pinion is a mechanical member comprising a screening shaft rotatable about a rotational axis, and a plurality of screening blades connected to the screening shaft and extending radially with respect to the rotational axis of the screening shaft.

Solutions of this type are known for example from U.S. Pat. No. 9,925,565B2, from the same applicant, and also from U.S. Pat. No. 7,506,461, EP2631371, EP2278078, EP2204501, CN205032239.

Since the presence of stones and rocks in the debris to be screened may cause very high stresses on the pinions, it is known to form both the screening blades and the screening shaft of steel, and to weld the screening blades to the screening shaft.

This solution, while satisfactory for the purpose of crushing and screening debris, involves significant operating and maintenance costs.

In fact, in case of damage or breakage to one of the screening blades of the pinion, it is necessary to replace the entire pinion with a new one, disassembling its support shaft and pulling out the pinion for its complete replacement.

The object of this invention is to provide a screening bucket such that it may overcome at least some of the drawbacks highlighted in the prior art.

A particular object of this invention is to provide a screening bucket that requires less complex maintenance and operation and reduced costs, while offering high mechanical strength.

### Solution

These and other objects are achieved by a screening bucket according to claim 1.

The dependent claims relate to preferred and advantageous embodiments of this invention.

### FIGURES

In order to better understand the invention and appreciate its advantages, some of its exemplifying and non-limiting embodiments will be described below, referring to the appended figures, wherein:

FIG. 1 is a rear perspective view of a screening bucket, according to an embodiment of the invention;

FIG. 2 is a front perspective view of the screening bucket in FIG. 1;

FIG. 3 is a cross-sectional view of the screening bucket in FIG. 1;

FIG. 4 is a longitudinal sectional view of the screening bucket in FIG. 1;

FIG. 5 is a perspective view of a screening bucket component, in a first assembly stage;

FIG. 6 is a perspective view of a screening bucket component, in a second assembly stage;

FIG. 7 is a perspective view of a screening bucket component, in a third assembly stage;

FIG. 8 is a perspective view of a screening bucket component, in a fourth assembly stage;

FIG. 9 is a perspective view of a screening bucket component, in a fifth assembly stage;

FIG. 10 is a perspective view of a screening bucket component, in a sixth assembly stage;

FIG. 11 is a top perspective view of a screening bucket component, in an assembled configuration;

FIG. 12 is a bottom perspective view of the component in the assembled configuration in FIG. 11;

FIG. 13 is a perspective view of a further component of a screening bucket, in an first assembly stage;

FIG. 14 is a perspective view of the component in FIG. 13, in a second assembly stage;

FIG. 15 is a perspective view of the component in FIG. 13, in a third assembly stage;

FIG. 16 is a perspective view of the component in FIG. 13, in a fourth assembly stage;

FIG. 17 is a cross-sectional view of the component in FIG. 11;

FIG. 18 is a longitudinal sectional view of the component in FIG. 11;

FIG. 19 is a perspective view of a further component of a screening bucket, in an first assembly stage;

FIG. 20 is a perspective view of the component in FIG. 19, in a second assembly stage;

FIG. 21 is a perspective view of the component in FIG. 19, in a third assembly stage;

FIG. 22 is a perspective view of the component in FIG. 19, in a fourth assembly stage;

FIG. 23 is a perspective view of the component in FIG. 19, in a fifth assembly stage;

FIG. 24 is a detail view of FIG. 21;

FIG. 25 is a detail view of FIG. 22;

FIG. 26 is a perspective view of an additional component of a screening bucket, in an assembled configuration;

FIG. 27 is a top view of the component in FIG. 26;

FIG. 28 is a front view of the component in FIG. 26;

FIG. 29 is a first cross-sectional view of the component in FIG. 27;

FIG. 30 is a second cross-sectional view of the component in FIG. 27;

FIG. 31 is a longitudinal sectional view of the component in FIG. 26;

FIG. 32 is a perspective view of a longitudinal section of a component of a screening bucket, according to an embodiment;

FIG. 33 is a front view of a component of a screening bucket, according to a further embodiment;

FIG. 34 is a top view of the component shown in FIG. 33;

FIG. 35 is a front view of a component of a screening bucket, according to a further embodiment;

FIG. 36 is a perspective view of the component shown in FIG. 35;

FIG. 37 is a front view of a component of a screening bucket, according to a further embodiment;

FIG. 38 is a perspective view of the component shown in FIG. 37;

FIG. 39 is a front view of a component of a screening bucket, according to a further embodiment;

FIG. 40 is a perspective view of the component shown in FIG. 39;

FIG. 41 is a perspective view of a component of a screening bucket, according to a further embodiment of the invention;

FIG. 42 is a longitudinal sectional view of the component shown in FIG. 41;

FIG. 43 is a perspective view of a component of a screening bucket, according to a further embodiment;

FIG. 44 is a perspective view from below of the partially assembled component in FIG. 43;

FIG. 45 is a cross-sectional view of the component shown in FIG. 43;

FIG. 46 is a side view of the component shown in FIG. 43;

FIG. 47 is a perspective view of a component of a screening bucket, according to a further embodiment;

FIG. 48 is a perspective view of a sub-component of the component shown in FIG. 48;

FIG. 49 is a side view of the component shown in FIG. 47;

FIG. 50 is a cross-sectional view of the component shown in FIG. 49;

FIG. 51 is a front view of the component shown in FIG. 47;

FIG. 52 is a longitudinal sectional view of the component shown in FIG. 51;

FIG. 53 is a perspective view of a component of a screening bucket, according to a further embodiment;

FIG. 54 is a longitudinal sectional view of the component shown in FIG. 53;

FIG. 55 is a perspective view of a component of a screening bucket, according to a further embodiment of the invention;

FIG. 56 is a front view of the component shown in FIG. 55;

FIG. 57 is a longitudinal sectional view of the component shown in FIG. 55;

FIG. 58 is an exploded perspective view of a component of a screening bucket, according to an embodiment of the invention;

FIG. 59 is a perspective view of the component shown in FIG. 58, in assembled configuration;

FIG. 60 is an exploded perspective view of a component of a screening bucket, according to an embodiment of the invention;

FIG. 61 is a perspective view of the component shown in FIG. 60, in a first assembly stage;

FIG. 62 is a perspective view of the component shown in FIG. 60 in a second assembly stage;

FIG. 63 is a perspective view of the component shown in FIG. 60, in a third assembly stage;

FIG. 64 is a perspective view of the component shown in FIG. 60, in assembled configuration;

FIG. 65 is a front view of the component shown in FIG. 64;

FIG. 66 is a longitudinal sectional view of the component shown in FIG. 65;

FIG. 67 is an exploded perspective view of a component of a screening bucket, according to an embodiment of the invention;

FIG. 68 is a perspective view of the component shown in FIG. 67, in a first assembly stage;

FIG. 69 is a perspective view of the component shown in FIG. 67, in a second assembly stage;

FIG. 70 is a perspective view of the component shown in FIG. 67, in a third assembly stage;

FIG. 71 is a perspective view of the component shown in FIG. 67, in assembled configuration;

FIG. 72 is a front view of the component shown in FIG. 71;

FIG. 73 is a longitudinal sectional view of the component shown in FIG. 72;

FIG. 74 is an axial sectional view of the component shown in FIG. 72;

FIG. 75 is an exploded perspective view of a component of a screening bucket, according to an embodiment of the invention;

FIG. 76 is a top view of the component shown in FIG. 75;

FIG. 77 is an axial sectional view of the component shown in FIG. 76;

FIG. 78 is a top view of a component of a screening bucket, according to a further embodiment;

FIG. 79 is an axial sectional view of the component shown in FIG. 78;

FIG. 80 is a perspective view of a component of a screening bucket, according to an embodiment of the invention, in a partially assembled configuration;

FIG. 81 is a top view of the component shown in FIG. 80, in an assembled configuration;

FIG. 82 is an axial sectional view of the component shown in FIG. 81;

FIG. 83 is a bottom perspective view of the component shown in FIG. 81;

FIG. 84 is a top perspective view of the component shown in FIG. 81;

FIG. 85 is a view of a component of a screening bucket, according to an embodiment, in a partially assembled configuration;

FIG. 86 is a top view of the component shown in FIG. 85, in an assembled configuration;

FIG. 87 is an axial sectional view of the component shown in FIG. 86;

FIG. 88 is a longitudinal sectional view of a screening bucket, according to an embodiment of the invention.

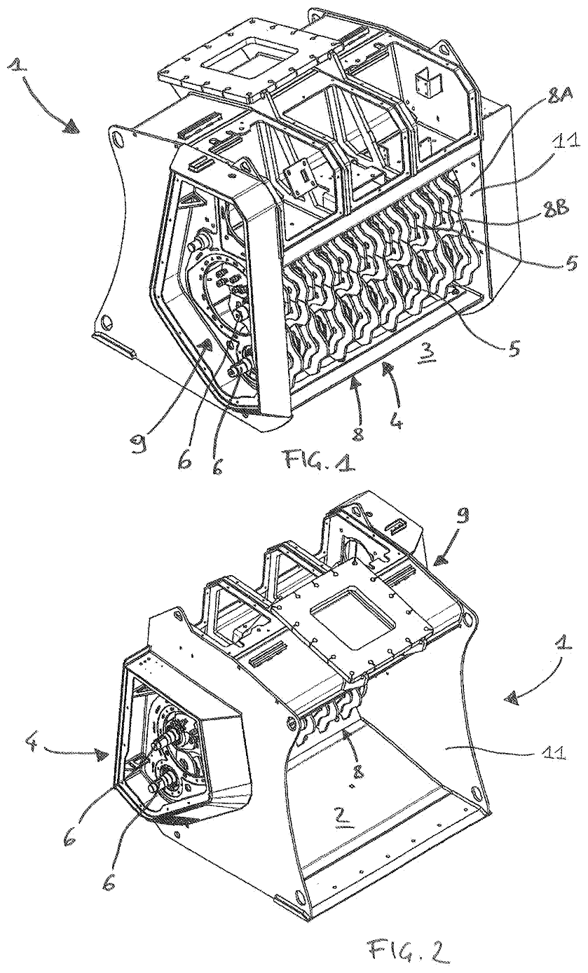

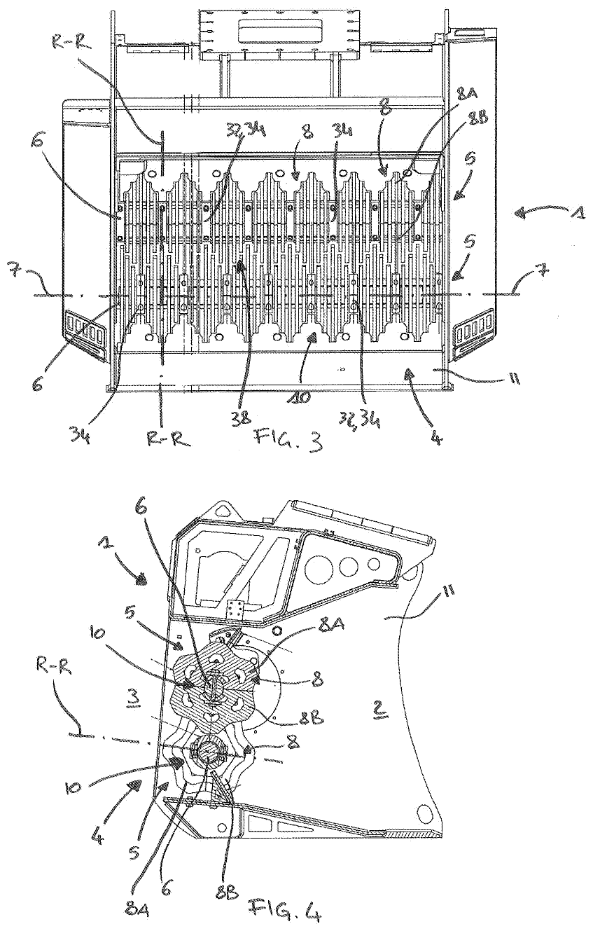

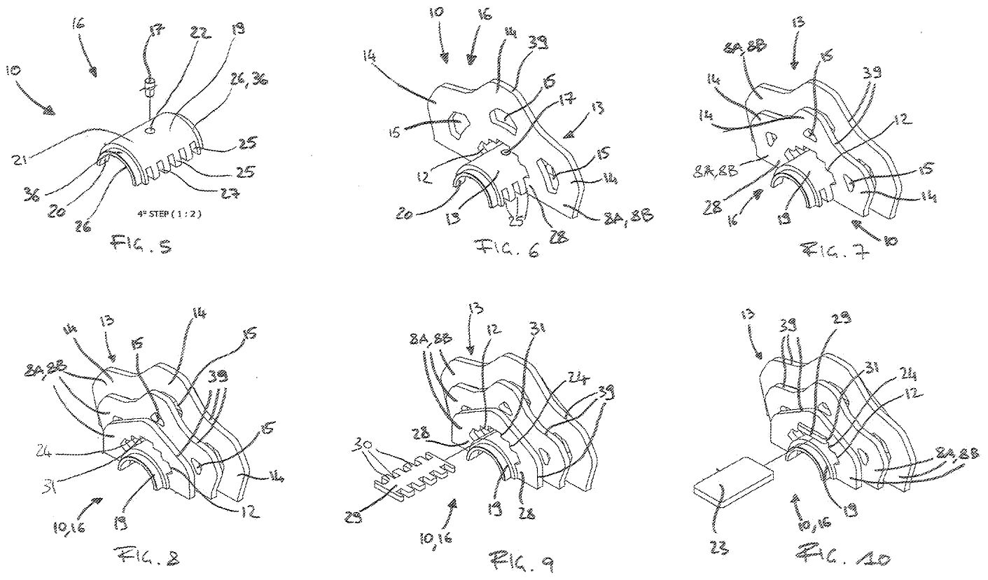

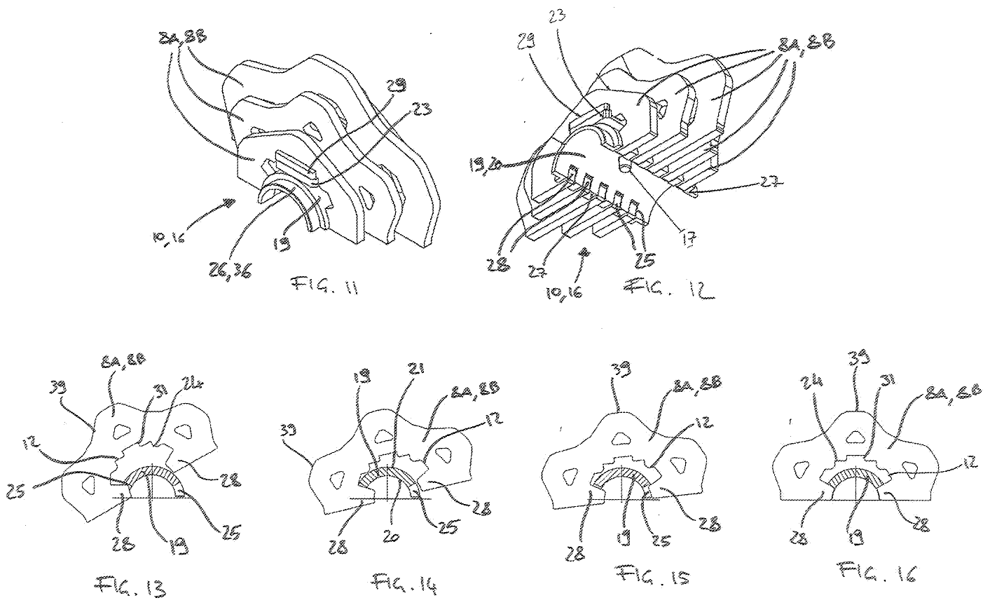

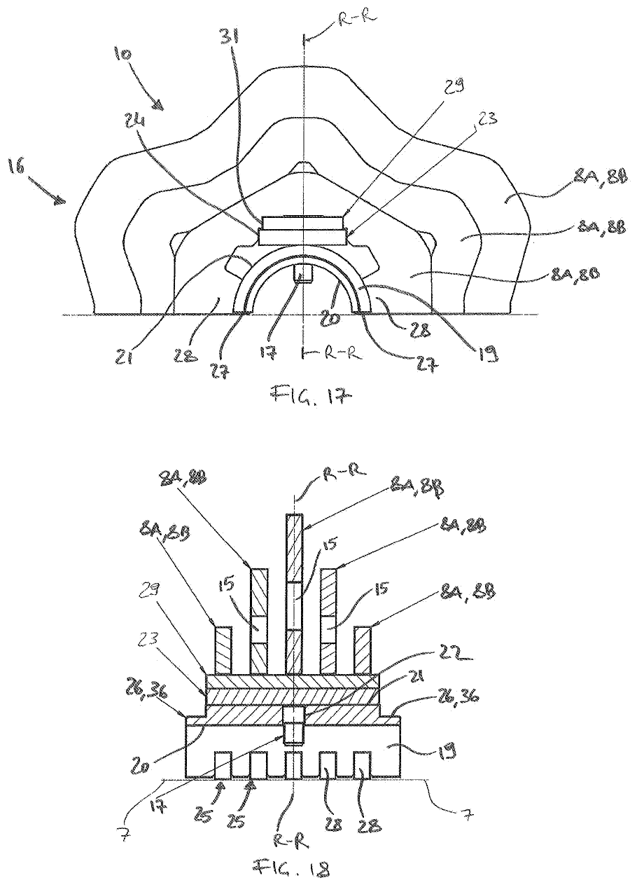

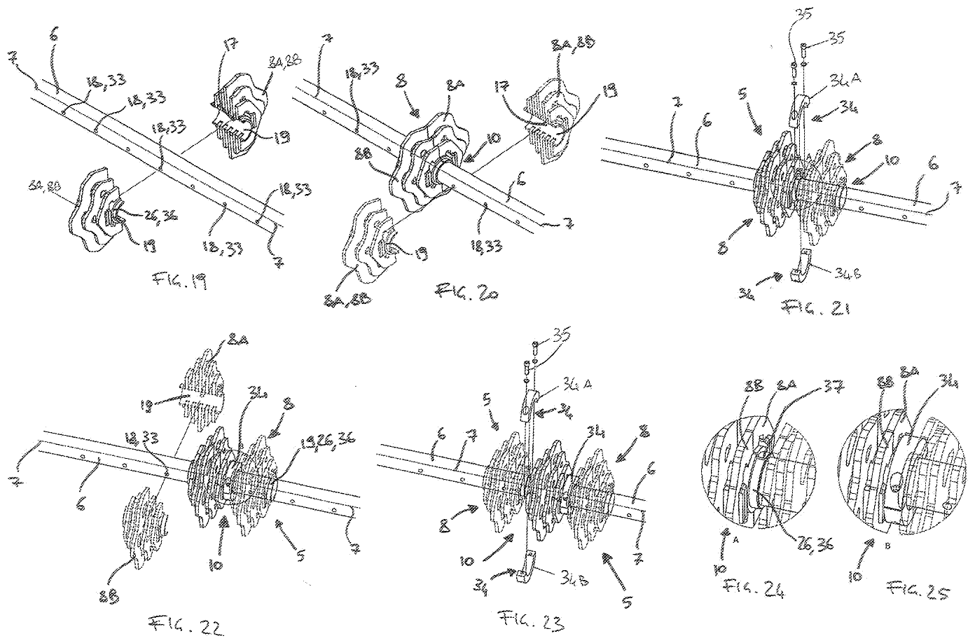

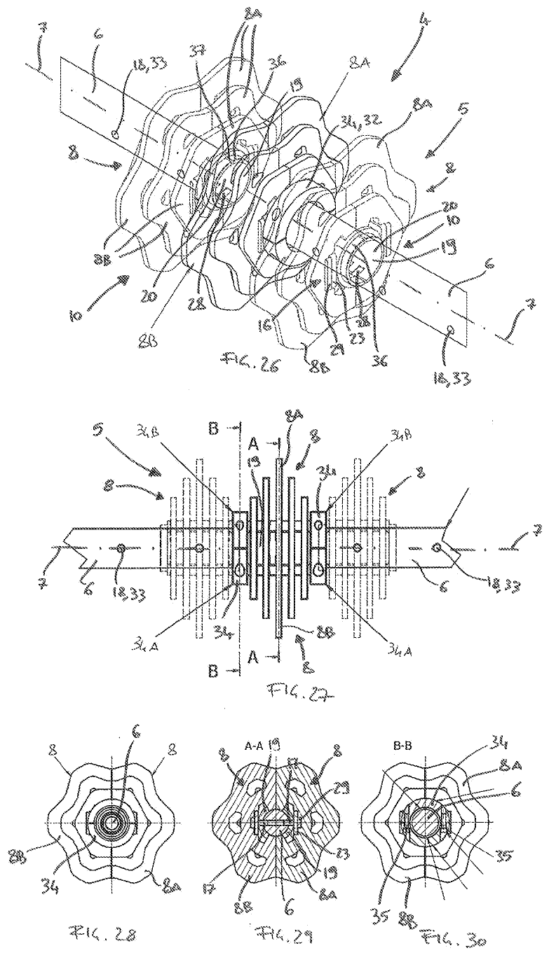

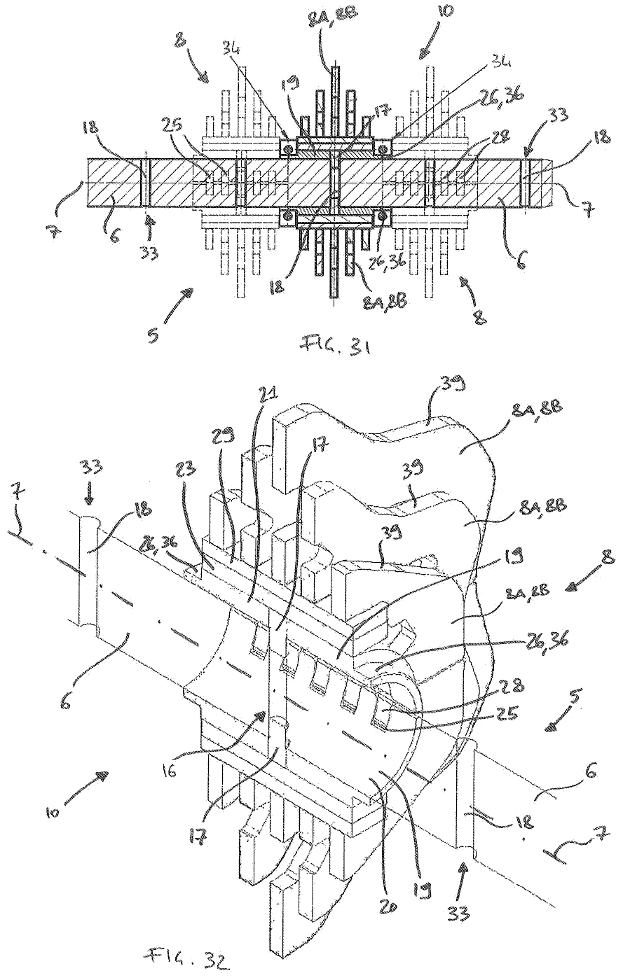

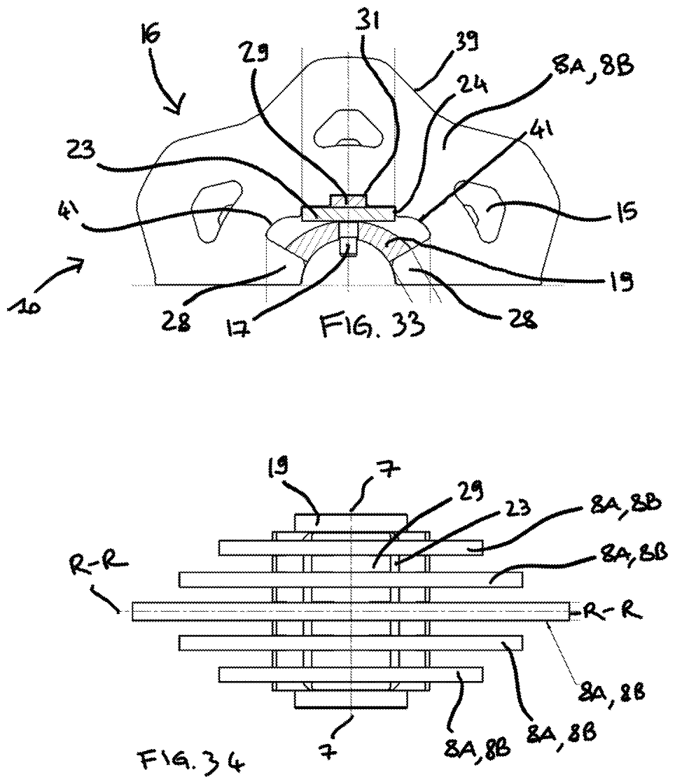

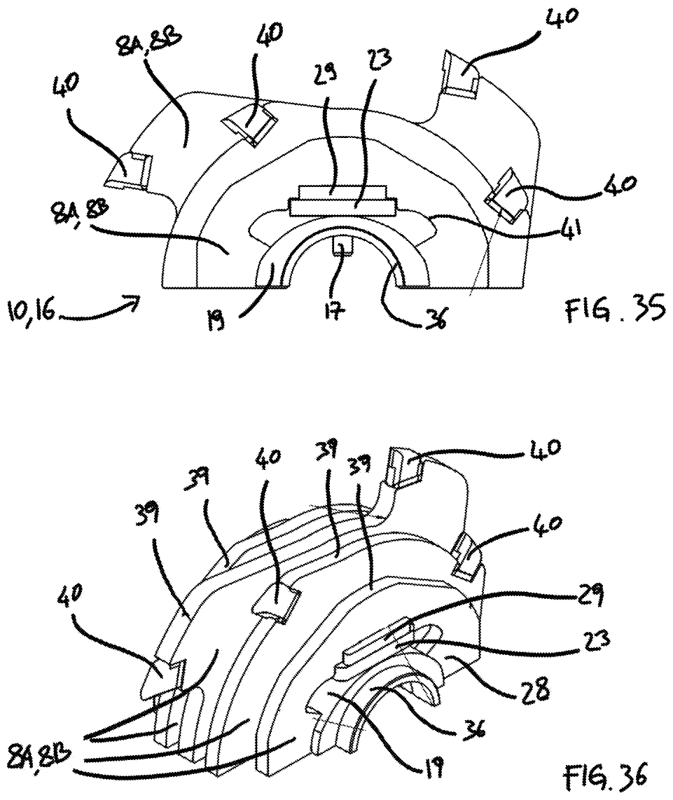

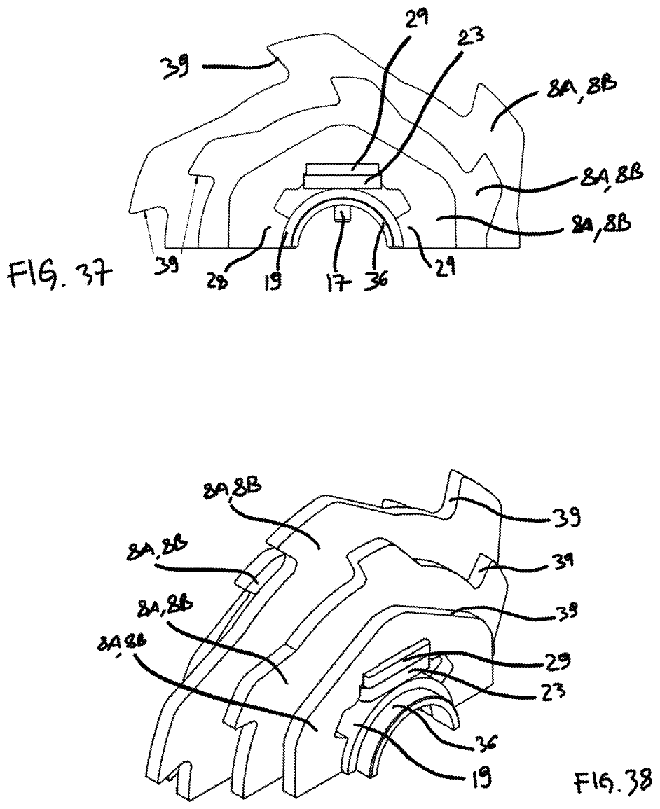

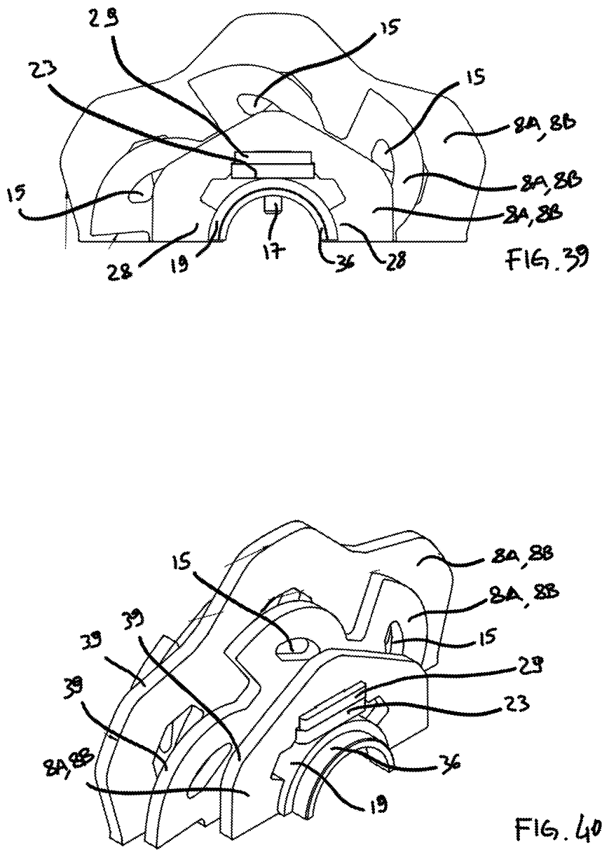

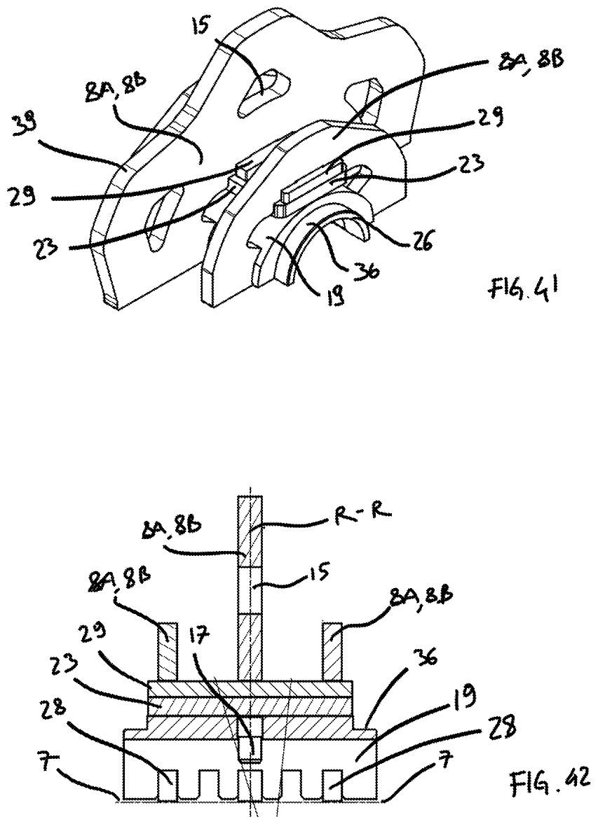

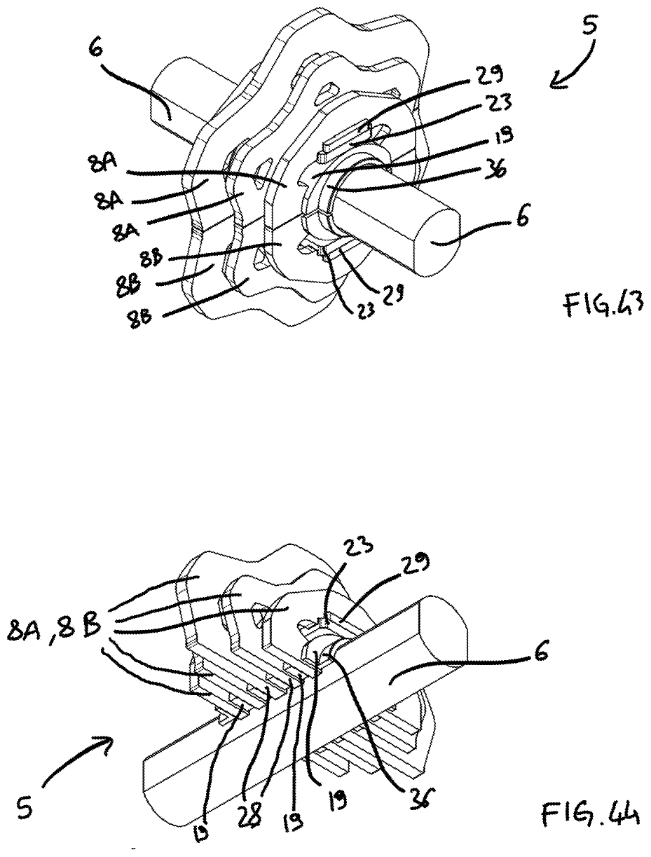

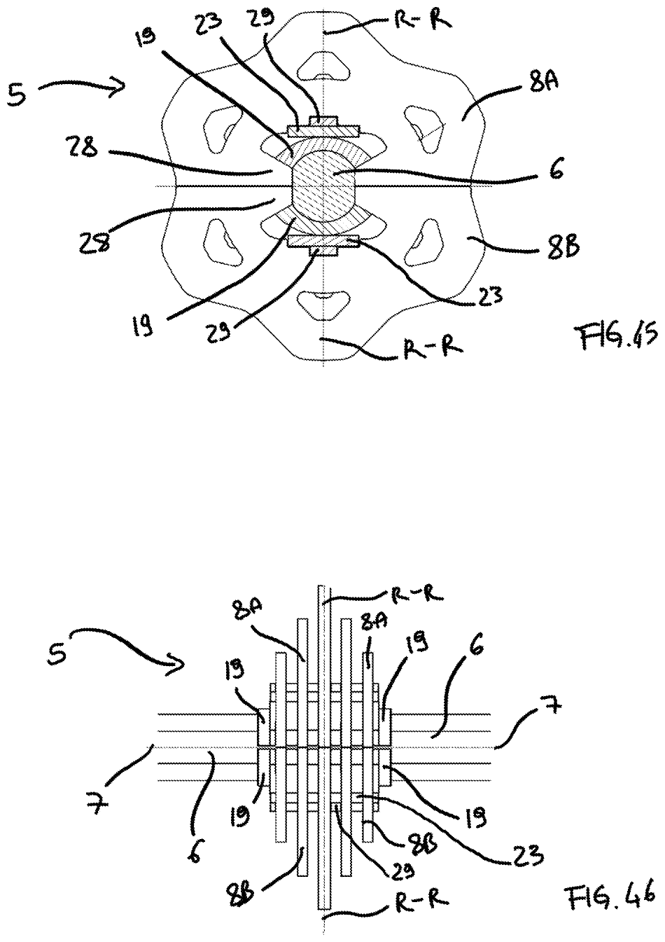

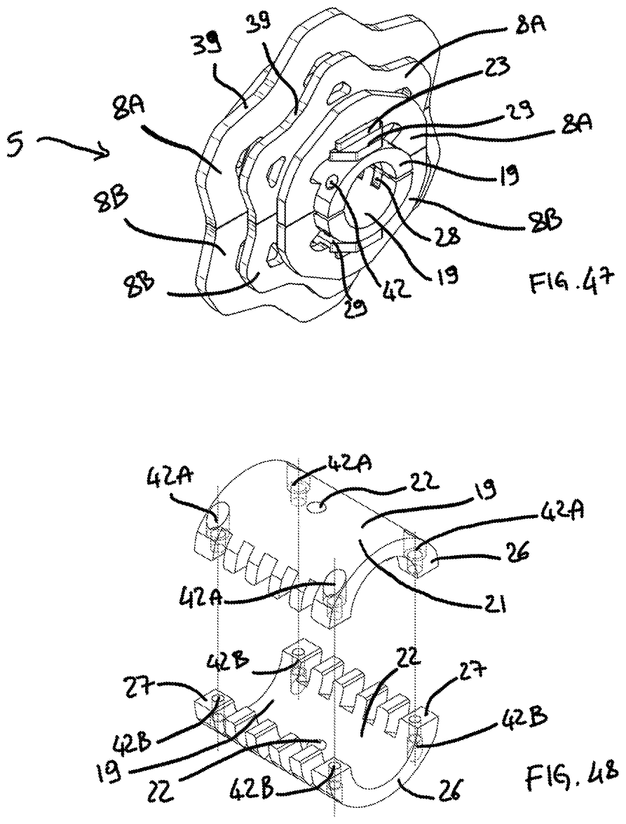

### DESCRIPTION OF SOME PREFERRED EXAMPLE EMBODIMENTS

With reference to the figures, a screening bucket is generally indicated with reference 1.

The screening bucket 1 comprises a box-shaped bucket body 11 defining a loading compartment 2 and an unloading opening 3.

The screening bucket 1 further comprises a screening unit 4 configured to screen debris material.

The screening unit 4 comprises at least one pinion 5, and drive and transmission means 9 configured to generate and transmit a rotary motion to the at least one pinion 5.

The screening unit 4 comprises at least one screening shaft 6 rotatable about a rotation axis 7. The at least one pinion 5 is mounted on the screening shaft 6.

Further, the at least one pinion 5 comprises a plurality of screening blades 8 connected to the screening shaft 6 and extending along a radial direction R-R orthogonal to the rotation axis 7.

According to an aspect of the invention, the at least one screening blade 8 of the plurality of screening blades 8 comprises two screening half-blades 8A, 8B connected to the screening shaft 6.

Further, each screening half-blade 8A, 8B is connected to the screening shaft 6 approaching along said radial direction R-R.

Further, each screening half-blade 8A, 8B is connected to the screening shaft 6 by a positive mechanical connection 10.

Further, the positive mechanical connection 10 is reversible, to allow said each half-blade 8A, 8B to be disconnected from said screening shaft 6.

A screening bucket 1 configured in this manner requires easier maintenance and handling.

In effect, in case of damage to a screening blade 8, or in case of a change of application, the screening bucket 1 so configured allows a localized and direct replacement of the single blade, or half-blade, with a new spare screening blade, or half-blade 8, or of a type more suitable for the new application.

As a further advantage, a screening bucket 1 so configured allows for localized replacement of the single blade, or half-blade, without therefore requiring handling and removal of the entire pinion, or additional screening blades arranged on the same pinion, in order to reach the screening single blade or half-blade 8 that is to be replaced.

Screening Half-Blade 8A, 8B

According to an embodiment, the screening half-blade 8A, 8B has a substantially plate-like shape.

The screening half-blade 8A, 8B defines a screening wall 39 facing away, or away from, the screening shaft 6 and configured to screen and crush debris material, and a connection wall 12 facing the screening shaft 6.

According to an embodiment, the screening wall 39 forms a scalloping 13.

According to an embodiment, the scalloping 13 comprises a plurality of scallops 14 with a substantially trapezoidal or arched shape.

According to an embodiment, the pinion 5 comprises at least two screening blades 8, wherein the scalloping 13 of one of the two screening blades 8 is different from the scalloping 13 of the other of the two screening blades 8.

According to an embodiment, the scalloping 13 of one of the two screening blades 8 forms a different number of scallops 14 with respect to the number of scallops 14 formed by the scalloping 13 of the other screening blade 8.

Alternatively, the pattern of the scallops 14 of one screening blade 8 differs from the pattern of the scallops 14 of the other screening blade 8 (FIG. 39-40).

According to a further alternative, the pattern of the scallops 14 of at least two screening blades 8 of the same pinion 5 is substantially identical (FIG. 37-38).

According to an embodiment, the screening half-blade 8A, 8B comprises at least one auxiliary screening element 40 connected to the screening wall 39 (FIG. 35-36). The at least one auxiliary screening element 40 is removably connectable or welded to the screening wall 39.

Advantageously, the arrangement of at least one screening auxiliary element 40 is carried out in relation to the specific material to be processed by the screening bucket 1, thereby making it more efficient and adaptable.

According to an embodiment, the screening half-blade 8A, 8B defines a plurality of lightening holes 15, internal to the screening half-blade 8A, 8B.

According to an embodiment, the screening half-blades 8A, 8B are made of steel.

Positive Mechanical Connection 10

According to an embodiment, two screening half-blades 8A, 8B of a same screening blade 8 are connected opposite to each other with respect to the screening shaft 6.

According to an embodiment, the positive mechanical connection 10 comprises positioning and fastening means 16 by which a screening half-blade 8A, 8B is connected to the screening shaft 6 at a predefined connection position 33.

According to an embodiment of the invention, the positioning and fastening means 16 comprise a pin 17 connected to the connection wall 12 of the screening half-blade 8A, 8B.

Further, the positioning and fastening means 16 comprise a positioning hole 18 defined by the screening shaft 6 and extending into the screening shaft 6 along the direction R-R.

The positioning hole 18 is configured to accommodate the pin 17.

According to an embodiment, the screening shaft 6 defines a pair of positioning holes 18, one opposite the other with respect to the rotation axis 7, for connecting two screening half-blades 8A, 8B of the same screening blade 8.

According to an embodiment, the screening shaft 6 defines a plurality of pairs of equally spaced positioning holes 18 along the screening shaft 6.

According to an embodiment of the invention, the positioning and fastening means 16 comprise a half-sleeve 19 connected to the screening half-blade 8A, 8B.

The half-sleeve 19 defines an internal half-sleeve wall 20 abutting against the screening shaft 6, an external half-sleeve wall 21 facing the connection wall 12 of the screening half-blade 8A, 8B, two semi-circumferential end walls 26, and two longitudinal edge walls 27.

According to an embodiment, the half-sleeve 19 defines a through hole 22, extending between the internal half-sleeve wall 20 and the external half-sleeve wall 21, for accommodating the pin 17.

The through hole 22 is defined at the positioning hole 18 of the screening shaft 6.

Further, the pin 17 extends through the positioning hole 18 and the through hole 22 so as to connect the half-sleeve 19 to the screening shaft 6.

According to an embodiment, the through hole 22 and the pin 17 are configured so that the pin 17 protrudes beyond the internal half-sleeve wall 20, but so that a total release of the pin 17 through the semi-cylindrical wall 20 is prevented.

According to an embodiment, a plurality of screening half-blades 8A, 8B are connected to the same half-sleeve 19, positioned parallel to each other.

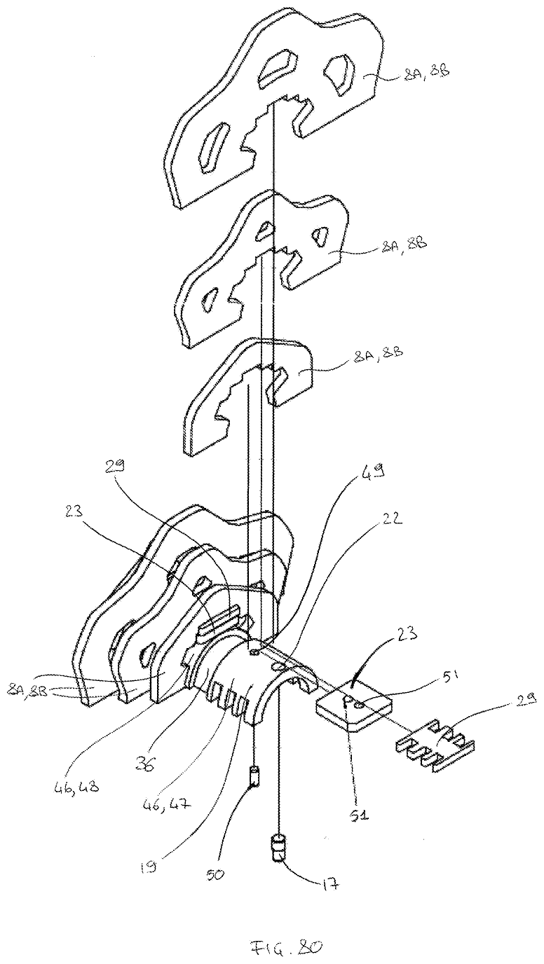

According to an embodiment (FIG. 75-79), the half-sleeve 19 defines a plurality of through holes 22 arranged in a direction longitudinal to the half-sleeve 19, parallel to the rotation axis 7.

Advantageously, a half-sleeve 19 configured in this manner allows the connection to a greater number of screening half-blades 8A, 8B, for example six to twenty screening half-blades 8A, 8B.

According to an embodiment, the positioning and fastening means 16 comprise a stop plate 23.

According to an embodiment, the stop plate 23 is positioned in abutment against the pin 17. Preferably, the stop plate 23 is positioned against the external half-sleeve wall 21.

The stop plate 23 prevents a possible release of the pin 17 through the external half-sleeve wall 21.

According to an embodiment, the connection wall 12 of the screening half-blade 8A, 8B defines a first shaped profile 24 at the stop plate 23.

The first shaped profile 24 is configured to allow for positioning the stop plate 23, preferably at the pin 17, and to constrain the stop plate 23 by means of shape coupling.

Specifically, the first shaped profile 24 is configured to allow for an insertion and positioning of the stop plate 23 along a direction parallel to the rotation axis 7, and to constrain the stop plate 23 via a shape coupling, preventing movements of the stop plate 23 in directions orthogonal to the rotation axis 7.

According to an embodiment, the stop plate 23 defines walls converging in a longitudinal direction. Such convergence simplifies the insertion of the stop plate 23 into the first shaped profile 24.

According to an alternative embodiment, the stop plate 23 defines planar and parallel walls.

According to the embodiment in which each half-sleeve 19 defines a plurality of through holes 22 (FIG. 75-79), a plurality of stop plates 23, one after the other, is positionable in abutment against the external half-sleeve wall 21 so as to prevent any release of the pins 17. According to this embodiment, a plurality of comb-like inserts 29, one after the other, is also positionable in connection with the plurality of screening half-blades 8A, 8B. In particular, the plurality of comb-like inserts 29 are interposable between the plurality of screening half-blades 8A, 8B and the plurality of stop plates 23. According to this embodiment, a plurality of clamping members 32, preferably circular clamps 34, are connectable at the ends of each half-sleeve 19, at a respective clamping seat 36, for clamping the plurality of screening half-blades 8A, 8B at a predetermined connection position. Naturally, it is foreseeable to implement in this embodiment all other connection and fastening means 16 so far and hereinafter described, as they are compatible with this embodiment.

According to an embodiment, each stop plate 23 of the plurality of stop plates 23 defines at least one lightening slot 45.

According to an embodiment, the connection wall 12 defines a connecting portion 41 between the first shaped profile 24 of the screening half-blade 8A, 8B and hooking protrusions 28 of the screening half-blade 8A, 8B (FIG. 33). Advantageously, the connecting portion 41 does not form sharp edges.

According to an embodiment, the connecting portion 41 defines, between a hooking protrusion 28 and the first shaped profile 24, a monotonic curve with respect to the radial direction R-R.

According to an alternative embodiment, the screening shaft 6 defines a polygonal external wall.

Further, the internal half-sleeve wall 20 defines a polygonal counter-wall configured to obtain a shape coupling with the external polygonal wall of the screening shaft 6 to allow torque transfer between the screening shaft 6 and the half-sleeve 19.

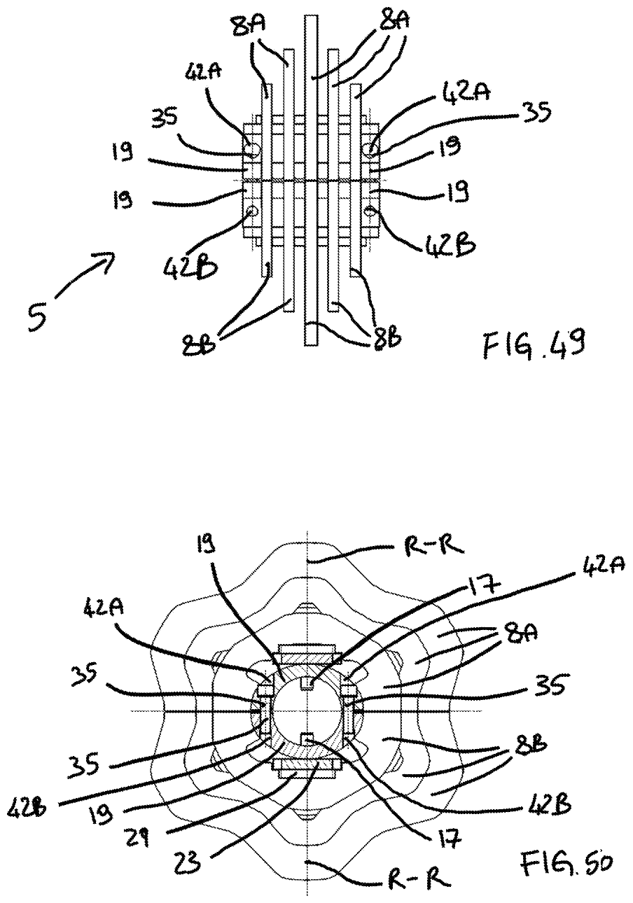

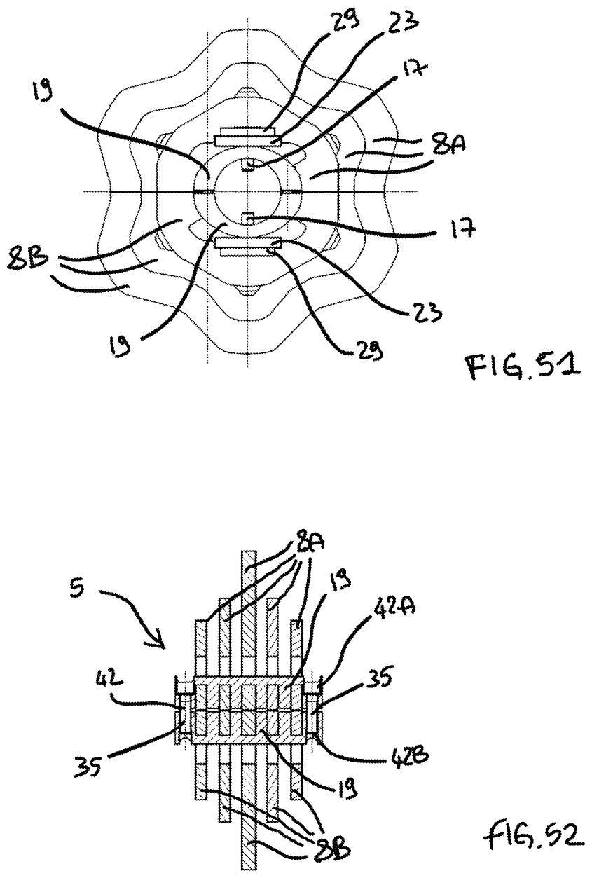

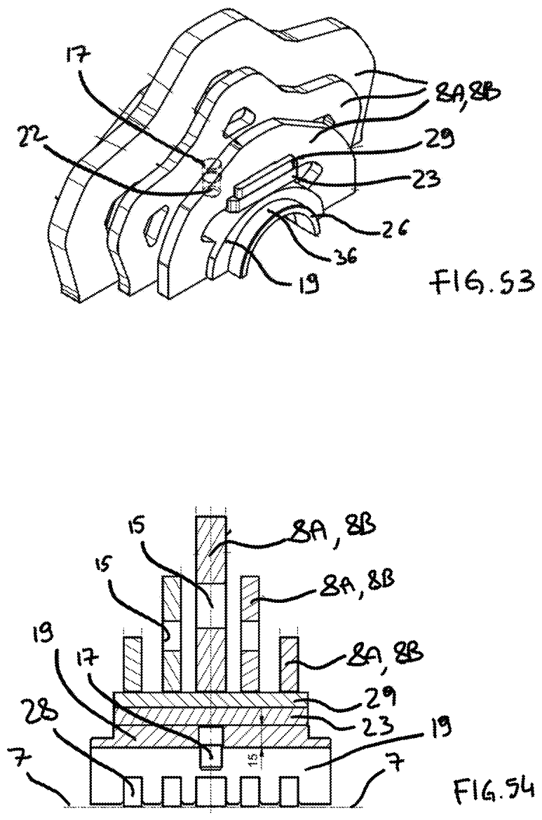

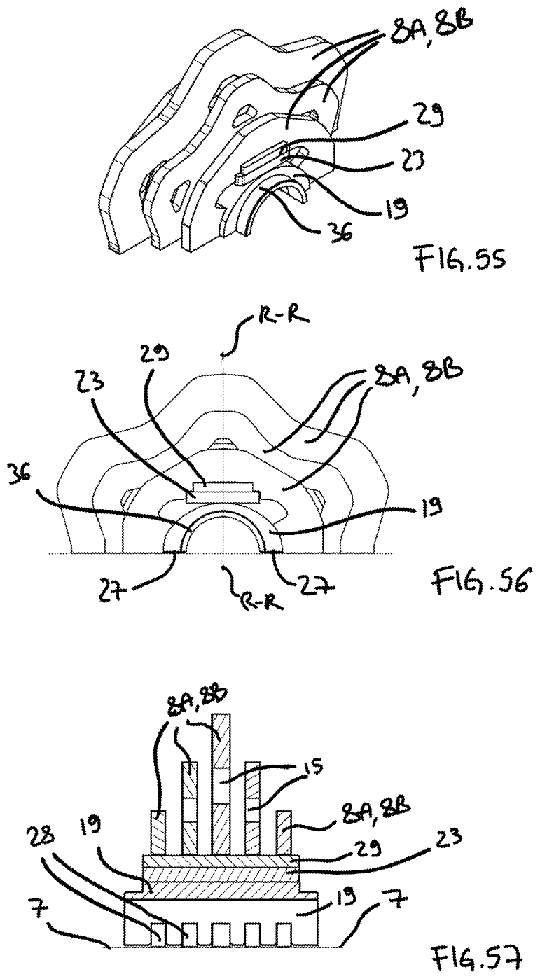

According to an alternative embodiment (FIG. 43-46), the screening half-blade 8A, 8B defines a polygonal counter-wall configured to obtain a shape coupling with the polygonal external wall of the shaft 6 to allow a torque transfer between the screening shaft 6 and the screening half-blade 8A, 8B.

According to an embodiment, the polygonal counter-wall is formed by the connection wall 12 of the screening half-blades 8A, 8B, at hooking protrusions 28 formed by the connection walls 12.

According to an embodiment, the at least one screening half-blade 8A, 8B is connected to the half-sleeve 19 by an undercut connection.

An undercut connection provides high mechanical strength, which allows the screening blades 8 to screen and crush debris material effectively and easily.

According to an embodiment, the half-sleeve 19 defines at least one pair of hooking slots 25 extending between the internal half-sleeve wall 20 and the external half-sleeve wall 21 and defined opposite each other at opposite longitudinal edge walls 27 of the half-sleeve 19.

According to this embodiment, the connection wall 12 of the screening half-blade 8A, 8B forms two hooking protrusions 28 configured to be insertable within the hooking slots 25.

Preferably, the hooking slots 25 and the hooking protrusions 28 obtain an undercut coupling that prevents a movement of the screening half-blade 8A, 8B in a direction parallel to the rotation axis 7.

According to an embodiment, the connection of a screening half-blade 8A, 8B to the half-sleeve 19 requires inserting a first hooking protrusion 28 into a hooking slot 25 (FIG. 13). Next, the first hooking protrusion 28 is further inserted into the hooking slot 25 so as to protrude into the half-sleeve 19 (FIG. 14). This subsequently allows the second hooking protrusion 28 to be inserted into the opposite hooking slot 25 (FIG. 15). Subsequently, the first and second hooking protrusions 28 are positioned to make an undercut connection with the half sleeve 19, with the hooking protrusions 28 not protruding into the half-sleeve 19 (FIG. 16).

According to an embodiment, the half-sleeve 19 defines a plurality of pairs of hooking slots 25 for connecting a plurality of screening half-blades 8A, 8B to the half-sleeve 19.

According to an embodiment, the half-sleeve 19 defines four pairs of hooking slots 25, for connecting four screening half-blades 8A, 8B, arranged parallel to each other and orthogonal to the rotation axis 7. Alternatively, the half-sleeve 19 defines five pairs of hooking slots 25, for connecting five screening half-blades 8A, 8B, arranged parallel to each other and orthogonal to the rotation axis 7.

According to a further embodiment, the screening half-blades 8A, 8B connected to the same half-sleeve 19 have different extensions in the direction R-R.

According to an embodiment, the positioning and fastening means 16 comprise a comb-like insert 29, forming a plurality of teeth 30.

The comb-like insert 29 is connected to the plurality of screening half-blades 8A, 8B connected to a same half-sleeve 19.

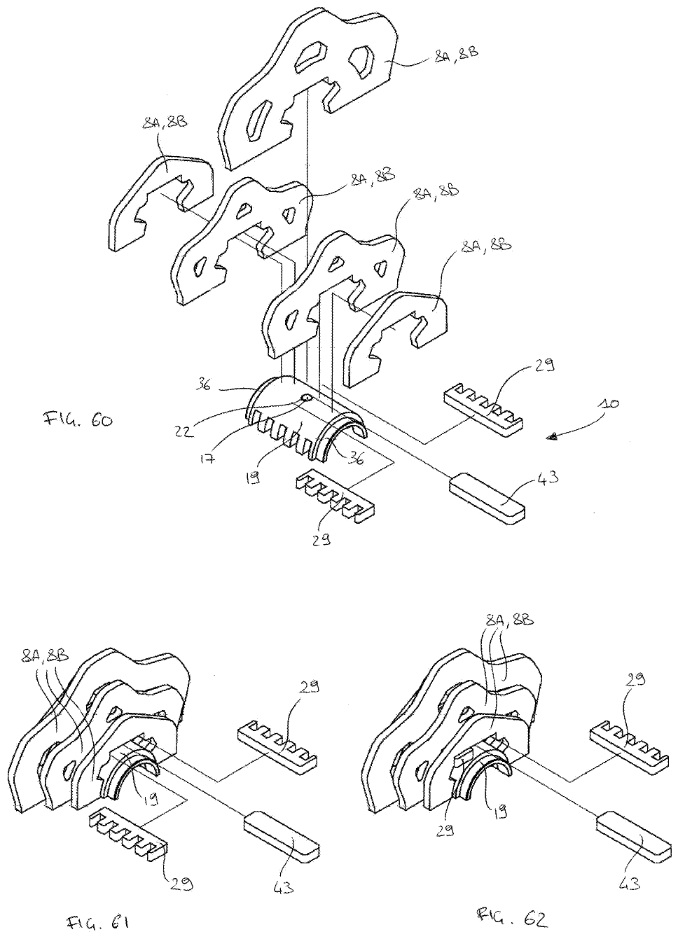

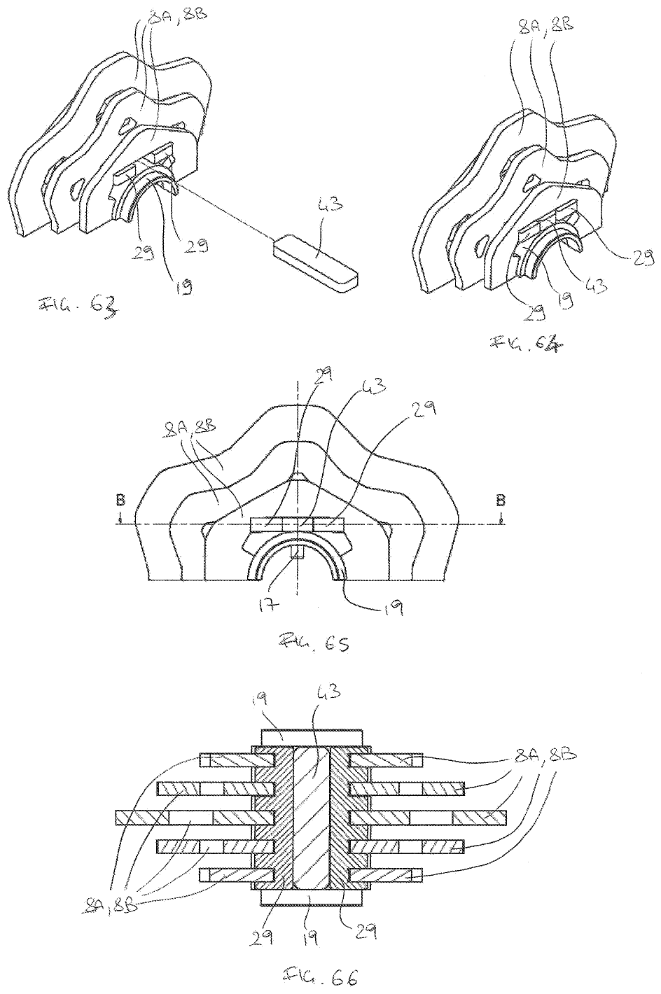

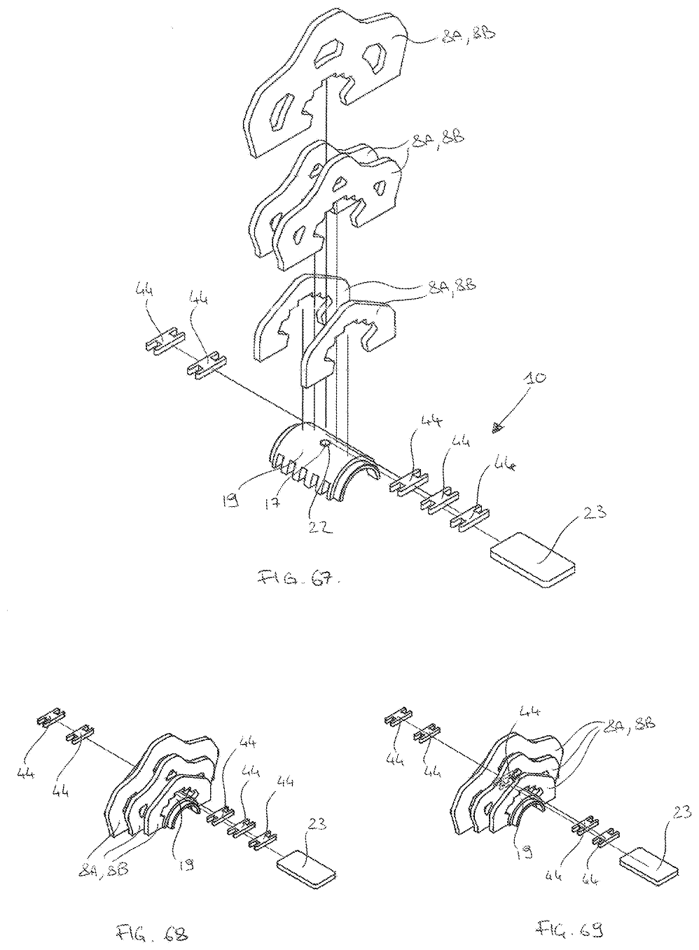

According to an embodiment (FIG. 60-66), the positioning and fastening means 16 comprise a comb-like insert 29, which is formed in two longitudinally separated pieces, and a wedge 43 insertable between the two pieces of the comb-like insert 29.

Advantageously, the wedge 43 is configured to widen the two pieces of the comb-like insert 29 by biasing them against the connection wall 12 of the screening half-blades 8A, 8B.

Preferably, the wedge 43 has a convergent profile in a longitudinal direction, which facilitates its insertion between the first piece and the second piece of the comb-like insert 29 and the subsequent widening between the first piece and the second piece of the comb-like insert 29.

According to an embodiment, the wedge 43 inserted between the two pieces of the comb-like insert 29 is positioned against the pin 17, so as to prevent any release of the pin 17 through the external half-sleeve wall 21.

According to an embodiment, the comb-like insert 29 is positioned at the stop plate 23 and interposed between the stop plate 23 and the connection wall 12.

According to an alternative embodiment, the comb-like insert 29 is positioned against the external half-sleeve wall 21 of the half-sleeve 19.

According to an embodiment, the connection wall 12 of the screening half-blade 8A, 8B defines a second shaped profile 31 at the comb-like insert 29.

The second shaped profile 31 is configured to allow for positioning the comb-like insert 29, and to constrain the comb-like insert 29 by means of a shape coupling between the second shaped profile 31 and the plurality of teeth 30.

Specifically, the second shaped profile 31 is configured to allow for an insertion and positioning of the comb-like insert 29 along a direction parallel to the rotation axis 7, and to obtain a subsequent engagement between the teeth 30 and the second shaped profile 31 of each screening half-blade 8A, 8B of the plurality of screening half-blades 8A, 8B connected to a same half-sleeve 19.

According to the embodiment comprising the comb-like insert 29 formed in two longitudinally separated pieces and a wedge 43, the second shaped profile 31 is configured to allow an insertion and positioning of the first piece and the second piece of the comb-like insert 29 along a direction parallel to the rotation axis 7, and to obtain a subsequent engagement between the teeth 30 of the first piece and the second piece of the comb-like insert with the second shaped profile 31. The engagement of the first piece and second piece of the comb-like insert 29 with the second shaped profile 31 defines a slot for inserting the wedge 43 between the first piece and second piece of the comb-like insert 29 (FIG. 61-64).

The comb-like insert 29 helps stabilize the positioning of the plurality of screening half-blades 8A, 8B connected to a same half-sleeve 19.

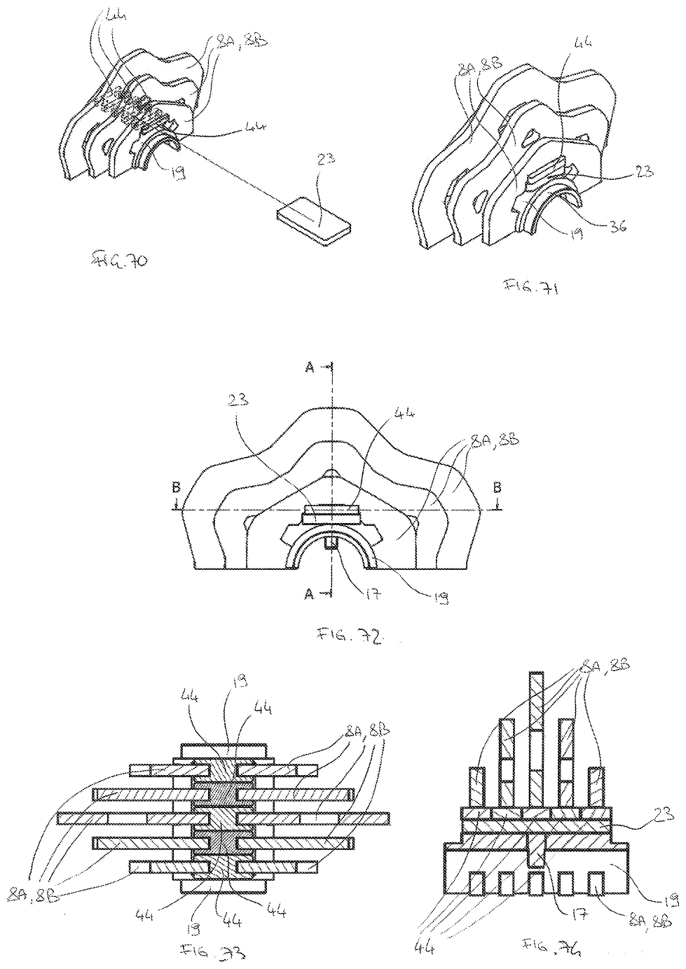

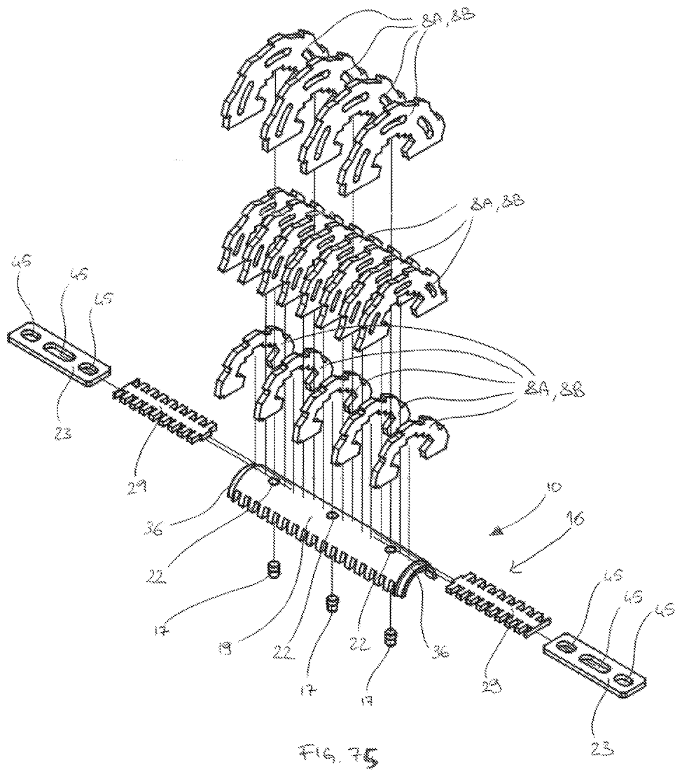

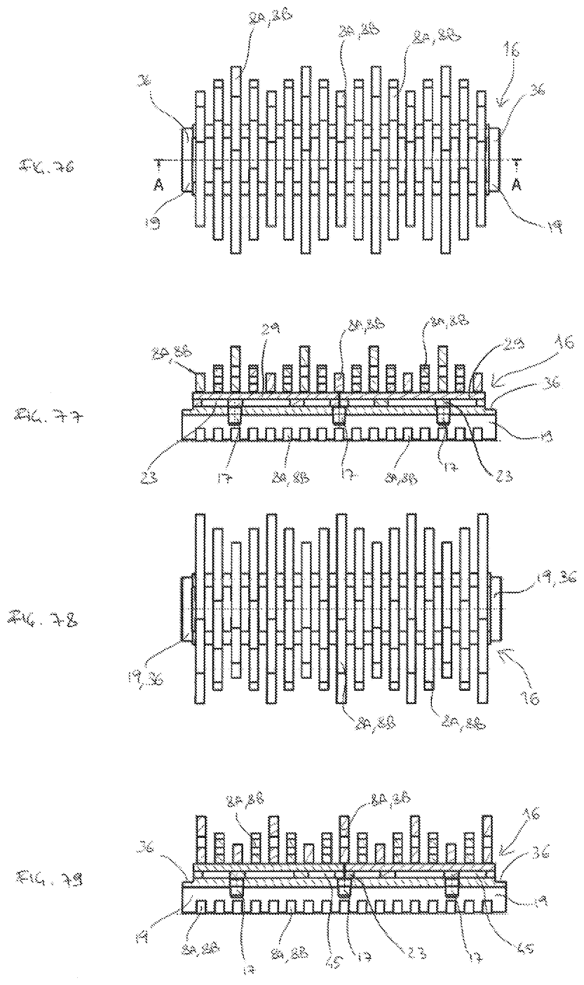

According to an embodiment (FIG. 67-74), the positioning and fastening means 16 comprise a plurality of stop forks 44 configured to obtain a shape coupling with the plurality of screening half-blades 8A, 8B connected to a same half-sleeve 19.

According to an embodiment, each stop fork 44 of the plurality of stop forks 44 is shaped in the form of an “H” and is configured to engage with the connection wall 12 of a corresponding screening half-blade 8A, 8B.

According to an embodiment, the plurality of stop forks 44 are positioned at the stop plate 23, interposed between the stop plate 23 and the connection wall 12 of the screening half-blades 8A, 8B connected to a same half-sleeve 19.

According to this embodiment, the second shaped profile 31 is configured to allow for an insertion and positioning of each stop fork 44 along a direction parallel to the rotation axis 7, to obtain a subsequent engagement between each stop fork 44 and each respective shaped profile 31, and to allow for the subsequent insertion of the stop plate 23 (FIG. 68-71).

According to an embodiment, each screening half-blade 8A, 8B is connected to a half-sleeve 19 by means of only the stop plate 23 or only the comb-like insert 29.

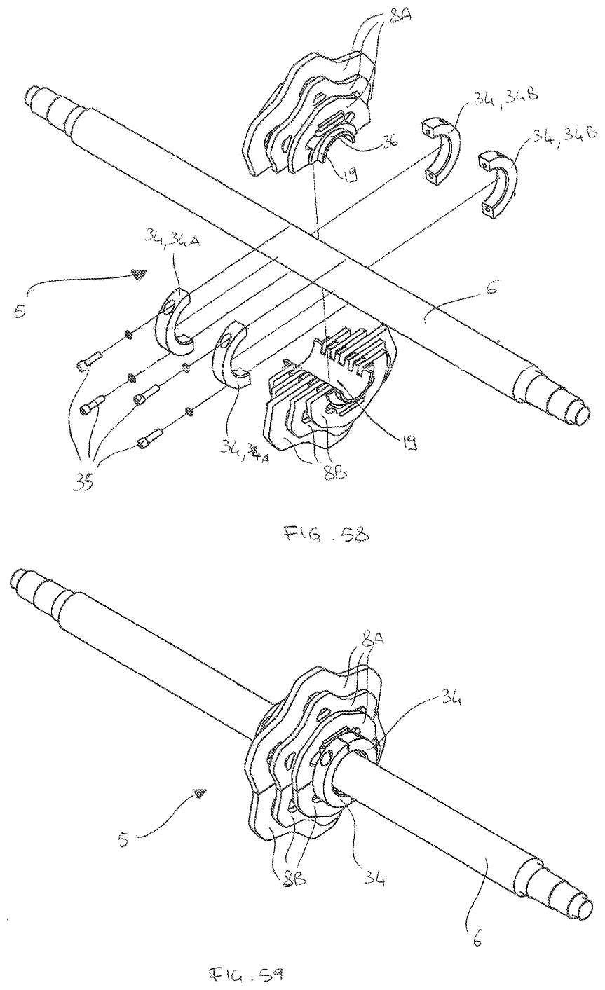

According to a further embodiment, each screening half-blade 8A, 8B is connected to a half-sleeve 19 by means of only the stop plate 23 and the comb-like insert 29 (FIG. 55-59). Advantageously, such a configuration requires neither the use of a pin 17 nor the provision of a through hole 22 within the half-sleeve 19, nor the provision of positioning holes 18 on the screening shaft 6.

According to an embodiment, each pair of opposing half-sleeves 19 and the screening shaft 6 obtains a force coupling with each other.

The force coupling is obtained by torque transfer facilitating means formed at the internal half-sleeve walls 20 and/or the screening shaft 6.

According to an embodiment, the torque transfer facilitating means are, for example, roughnesses, ridges, or knurls defined on the internal half sleeve walls 20 and/or on the screening shaft 6.

According to an embodiment, the connecting and fastening means 16 comprise a clamping member 32 configured to tighten a screening half-blade 8A, 8B in the predefined connection position 33.

According to an embodiment, the clamping member 32 is a circular clamp 34.

The circular clamp 34 comprises a half-clamp with smooth holes 34A and a half-clamp with threaded holes 34B, positioned opposite each other with respect to the screening shaft 6.

Further, the circular clamp 34 comprises clamping screws 35 adapted to screw the half-clamp with smooth holes 34A against the half-clamp with threaded holes 34B.

According to an embodiment, the half-clamp with smooth holes 34A and the half-clamp with threaded holes 34B are clamped against each other in a direction orthogonal to the coupling direction of two screening half-blades 8A, 8B of the same screening blade 8.

This configuration strengthens the clamping of the screening blades 8 to the screening shaft 6.

According to a further embodiment, the circular clamp comprises two half-clamps with smooth holes 34A positioned opposite to each other with respect to the screening shaft 6.

According to this embodiment, the two opposite circular half-clamps with smooth holes 34A are tightened against each other with bolts.

According to an embodiment, the circular clamp 34 is positioned at the semi-circumferential end walls 26 of a half-sleeve 19 and is configured to tighten the semi-circumferential end walls 26 against the screening shaft 6.

According to an embodiment of the invention, the half-sleeve 19 defines a clamping seat 36 at each semi-circumferential end wall 26.

The circular clamp 34 is positioned in the clamping seat 36.

Positioning the circular clamp 34 in the clamping seat 36 reduces the exposure of the circular clamp 34 to the debris material being screened.

According to an embodiment, the circular clamp 34 is positioned in the clamping seats 36 of a pair of half-sleeves 19 of the same screening blade 8.

A pair of half-sleeves 19 means the two half-sleeves 19 positioned one opposite the other with respect to the screening shaft 6, and to which the two screening half-blades 8A, 8B of a same screening blade 8 are connected, respectively.

Thus, the circular clamp 34 clamps the two screening half-blades 8A, 8B of a same screening blade 8 against the screening shaft 6.

According to an embodiment, a plurality of pairs of half-sleeves 19 are positioned against each other along the screening shaft 6, and the circular clamp 34 is positioned in the adjacent clamping seats 36 of two adjacent pairs of half-sleeves 19.

Thus, only one circular clamp 34 is necessary to tighten two adjacent half-sleeves 19 against the screening shaft 6.

According to an embodiment, each clamping seat 36 defines a coupling recess 37.

The coupling recess 37 allows the circular clamps 34 to be connected to the clamping seats 36 in a predetermined orientation with respect to the screening shaft 6 (FIG. 24, 26).

According to an embodiment, the plurality of circular clamps 34 that tighten the plurality of half-sleeves 19 against the screening shaft 6 all have the same orientation relative to the screening shaft 6.

According to an embodiment (FIG. 47-52), each pair of half-sleeves 19 defines a pair of clamping holes 42 at each semi-circumferential end wall 26.

Each pair of clamping holes 42 is defined by a pair of through clamping holes 42A defined at the semi-circumferential end wall 26 of a half-sleeve 19, and an opposite pair of threaded clamping holes 42B defined in the opposite semi-circumferential end wall 26 of the opposite half-sleeve 19. Alternatively, each pair of clamping holes 42 is defined by a pair of through clamping holes 42A defined at the semi-circumferential end wall 26 of a half-sleeve 19 and by an opposite pair of additional through clamping holes 42A defined in the opposite semi-circumferential end wall 26 of the opposite half-sleeve 19, and wherein the two opposite half-sleeves 19 are clamped against each other by bolts.

According to an embodiment, the clamping holes 42 extend through the half-sleeve 19 from the external half-sleeve walls 21 to the longitudinal edge walls 27.

The half-sleeves 19 thus configured are clamped against each other with respect to the screening shaft 6 by means of clamping screws 35 that may be screwed into the clamping holes 42.

Advantageously, such a configuration of the half-sleeves 19 does not require additional clamping means, such as circular clamps 34.

According to an embodiment, the thickness of the half-sleeves 19, i.e., the distance between the external half-sleeve wall 21 and the internal half-sleeve wall 20, is at the maximum at the longitudinal edge walls 27, and at the minimum at a median area, i.e., a vertex area, of the half-sleeve 19.

Therefore, the external half-sleeve wall 21 has a substantially oval shape.

Advantageously, the oval shape of the external half-sleeve wall 21, in combination with the substantially circular shape of the internal half-sleeve wall 20, obtains an increase in the resistant surface area of the half-sleeve 19 precisely at its area most subject to stress.

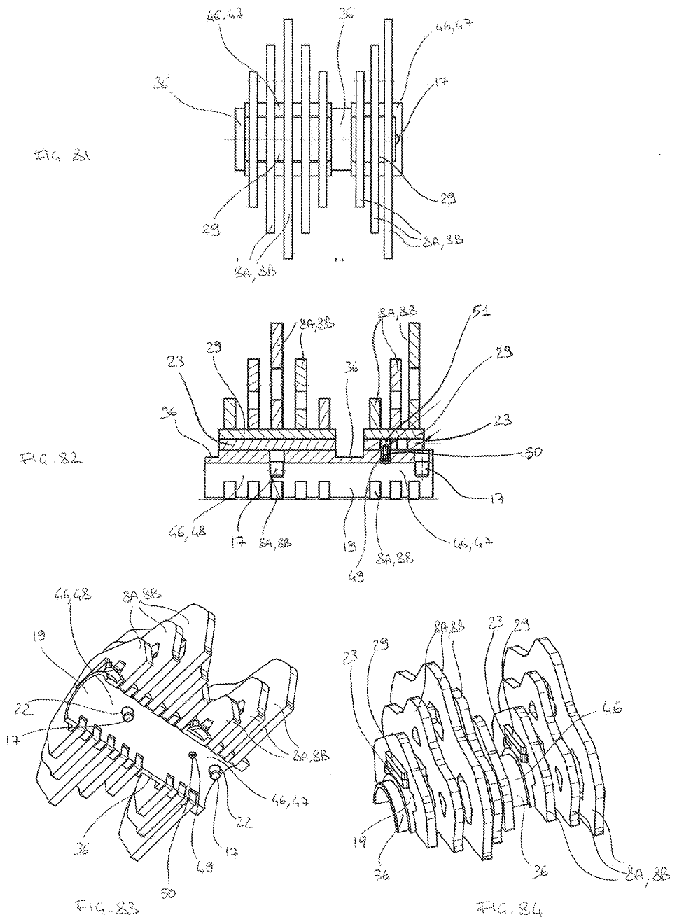

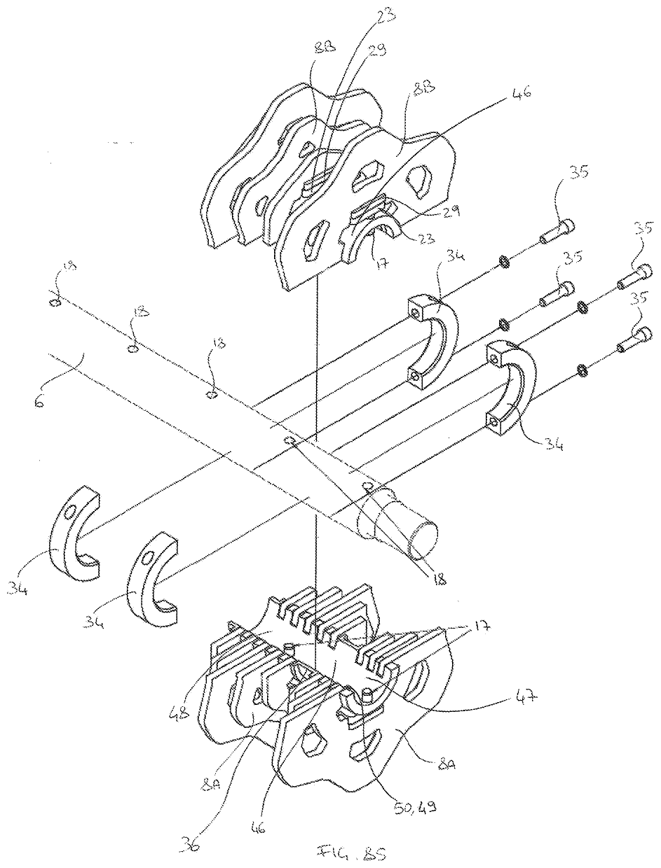

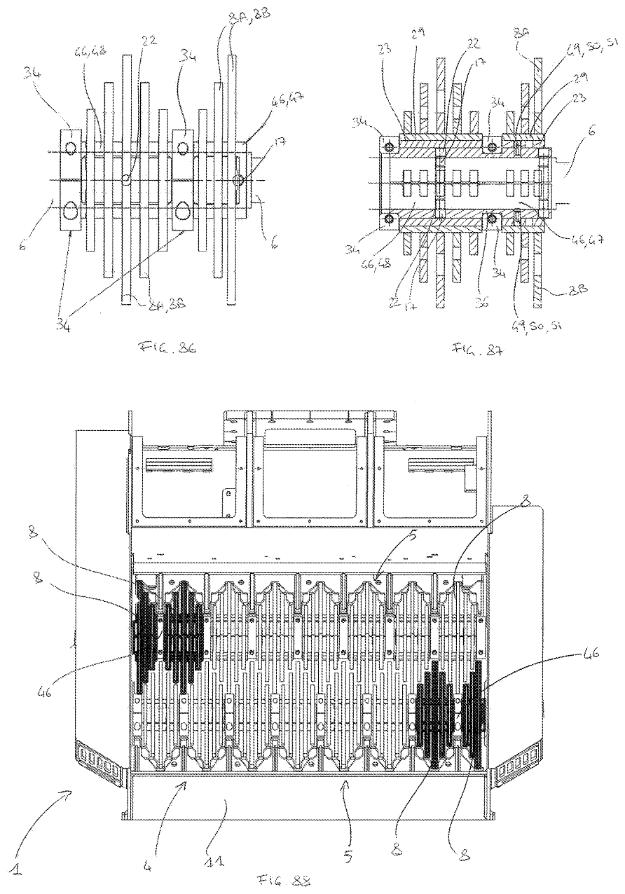

According to an embodiment (FIG. 80-88), the plurality of pairs of half-sleeves 19 connected to a same screening shaft 6 comprises at least one end half-sleeve 46 connected to an end of the screening shaft 6.

The end half-sleeve 46 defines at least one through hole 22 for a connection of the end half-sleeve 46 to the screening shaft 6 by at least one respective pin 17.

Further, the end half-sleeve 46 defines a clamping seat 36 interposed between the through holes 22.

The clamping seat 36 delimits a first end half-sleeve portion 47 and a second end half-sleeve portion 48, wherein the first end half-sleeve portion 47 faces the end of the screening shaft 6, and the second end half-sleeve portion 48 faces opposite the end of the screening shaft 6, and wherein the at least one through hole 22 is defined in the first end half-sleeve portion 47, or the at least one through hole 22 is defined in the second end half-sleeve portion 48.

Advantageously, the clamping seat 36 interposed between the first end half-sleeve portion 47 and the second end half-sleeve portion 48 prevents a possible release of the stop plate 23 positioned at the second end half-sleeve portion 48.

According to an embodiment, the first end half-sleeve portion 47 defines an additional through hole 49 extending between the internal half-sleeve wall 20 and the external half-sleeve wall 21.

According to this embodiment, the stop plate 23 positioned at the first end half-sleeve portion 47 defines an auxiliary through hole 51 at the additional through hole 49.

Further, the positioning and fastening means 16 comprise an additional pin 50 configured to be insertable through the additional through hole 49 and the auxiliary through hole 51, whereby the stop plate 23 is constrained to the first portion of the end half-sleeve 47.

Advantageously, the additional pin 50 prevents a possible release of said stop plate 23 positioned at the first end half-sleeve portion 47.

According to an embodiment, the stop plate 23 positioned at the first portion of the end half-sleeve 47 defines two auxiliary through holes 51.

Advantageously, two auxiliary through holes 51 make the stop plate 23 symmetrical.

According to an embodiment, the first end half-sleeve portion 47 has a longitudinal extension substantially equal to one half of the longitudinal extension of the second end half-sleeve portion 48.

According to this embodiment, the stop plate 23 and the comb-like insert 29 positioned at the first end half-sleeve portion 47 have a longitudinal extension substantially equal to one half of the longitudinal extension of the stop plate 23 and of the comb-like insert 29 positioned at the second end half-sleeve portion 48.

Screening Bucket 1

According to an embodiment, the screening bucket 1 comprises two pinions 5.

Preferably, the pinions 5 are positioned at the unloading opening 3.

According to an embodiment, each shaft comprises from one to ten pairs of half-sleeves 19.

Preferably, each shaft comprises eight pairs of half-sleeves 19.

According to an embodiment, the screening blades 8 have different radial extensions and are positioned on the two pinions 5 in such a way as to make a substantially wavy or “zig-zag” passage 38 between the two pinions 5.

A passage 38 configured in this manner increases the efficiency of the screening process.

According to an embodiment, five screening blades 8 are connected to each pair of half-sleeves 19, of which two screening blades 8 of lesser radial extension are arranged at two ends of the half-sleeves 19, one screening blade 8 of greater radial extension is positioned at a median area of the half-sleeves 19, and two screening blades 8 of radial extension intermediate between the lesser and greater radial extension are each interposed between a screening blade 8 of lesser radial extension and the screening blade 8 of greater radial extension.

According to an embodiment, of the five screening blades 8 connected to a pair of half-sleeves 19, the screening blade 8 with greater radial extension has a greater thickness than the thickness of the screening blades 8 with lesser radial extension and the screening blades 8 with intermediate radial extension (FIG. 34, 53-54). Preferably, the thickness of the screening blade 8 with greater extension is substantially twice the thickness of the screening blades 8 with lesser radial extension and the screening blades 8 with intermediate radial extension.

According to an embodiment, three screening blades 8 are connected to two half-sleeves 19 each defining five pairs of hooking slots 25, wherein two screening blades 8 with lesser radial extension are arranged at two ends of the half-sleeves 19 and one screening blade 8 with greater radial extension is positioned at a median area of the half-sleeves 19 (FIG. 41-42).

Advantageously, said configuration obtains an increased clearance between the screening blade 8 with greater radial extension and the screening blades 8 with lesser radial extension.

According to an embodiment (FIG. 76-79), the “zig-zag” passage 38 between a first and a second screening shaft 6 that face each other is made by placing two screening blades 8 of greater radial extension at the two respective ends of the first screening shaft 6, and by positioning two screening blades 8 of lesser radial extension at two respective ends of the second screening shaft 6 facing the first screening shaft 6.

According to an embodiment (FIG. 80-88), the “zig-zag” passage 38 between a first and a second screening shaft 6 that face each other is obtained by placing an end half-sleeve 46, as previously described, at an end of the first screening shaft 6 facing a first wall of the box-shaped bucket body 11, and positioning an end half-sleeve 46 at an end of the second screening shaft 6 facing a second wall of the box-shaped bucket body 11, wherein the first wall of the box-shaped bucket body 11 is opposite the second wall of the box-shaped bucket body 11.

According to an embodiment, the end half-sleeves 46 are positioned at the ends of the same screening shaft 6, respectively.

According to this embodiment, a screening blade 8 of greater radial extension is positioned in each end half-sleeve 46, facing the box-shaped bucket body 11 (FIG. 88).

Screening Blade 8

According to a further aspect of the invention, a screening blade 8 is applicable to a screening shaft 6 of a screening bucket 1 as described above, and comprises two screening half-blades 8A, 8B configured to be connectable to the screening shaft 6.

Further, each screening half-blade 8A, 8B is connectable to the screening shaft 6 approaching said screening shaft 6 along the radial direction R-R.

Further, each screening half-blade 8A, 8B is connectable to the screening shaft 6 via a positive mechanical connection 10.

Further, the positive mechanical connection 10 is reversible.

Set of Screening Blades 8

According to a further aspect of the invention, a set of screening blades 8, applicable to a screening shaft 6 of a screening bucket 1 as previously described, comprises a plurality of screening blades 8, wherein each screening blade 8 comprises two screening half-blades 8A, 8B configured to be connectable to the screening shaft 6.

Further, each screening half-blade 8A, 8B is connectable to the screening shaft 6 approaching said screening shaft 6 along the radial direction R-R.

Further, each screening half-blade 8A, 8B is connectable to the screening shaft 6 via a positive mechanical connection 10.

Further, the positive mechanical connection 10 is reversible to allow said each half-blade 8A, 8B to be disconnected from said screening shaft 6.

Assembly Method

According to a further aspect of the invention, a method for assembling a screening blade 8 to a screening shaft 6 of a screening bucket 1 as previously described comprises the steps of:
connecting the first of the two screening half-blades 8A to the screening shaft 6, approaching said screening shaft 6 along a radial direction R-R orthogonal to the rotation axis 7;
connecting the second of the two screening half-blades to the screening shaft 6, approaching said screening shaft 6 along a radial direction R-R orthogonal to the rotation axis 7;
connecting the two screening half-blades 8A, 8B by means of a mechanical coupling 10, wherein the mechanical coupling 10 is reversible to allow said each screening half-blade 8A, 8B to be disconnected from said screening shaft 6.

According to an embodiment, connecting the first of the two screening half-blades 8A to the screening shaft 6 comprises the steps of:
inserting a pin 17 into a through hole 22 of a half-sleeve 19;
connecting a plurality of screening half-blades 8A to the half-sleeve 19;
connecting a comb-like insert 29 to the plurality of screening half-blades 8A;
positioning a stop plate 23 at the pin 17, interposed between the half-sleeve 19 and the comb-like insert 29;
inserting the pin 17 into a positioning hole 18 of the screening shaft 6.

Further, connecting the second of the two screening half-blades 8B to the screening shaft 6 comprises the steps of:
inserting a pin 17 into a through hole 22 of a half-sleeve 19;
connecting a plurality of screening half-blades 8B to the half-sleeve 19;
connecting a comb-like insert 29 to the plurality of screening half-blades 8B;
positioning a stop plate 23 at the pin 17, interposed between the half-sleeve 19 and the comb-like insert 29;
inserting the pin 17 into a positioning hole 18 of the screening shaft 6.

Further, connecting the two screening half-blade 8A, 8B via a mechanical coupling 10, wherein the mechanical coupling 10 is reversible, comprises the step of:
tightening the two half-sleeves 19, or more preferably two pairs of half-sleeves 19, against the screening shaft 6 using a circular clamp 34.

According to an embodiment, connecting the first of the two screening half-blades 8A to the screening shaft 6 comprises the steps of: connecting a plurality of screening half-blades 8A to the half-sleeve 19;
connecting a comb-like insert 29 to the plurality of screening half-blades 8A;
positioning a stop plate 23 between the half-sleeve 19 and the comb-like insert 29;
connecting the plurality of screening half-blades 8A to the screening shaft 6, approaching said screening shaft 6 along a radial direction R-R orthogonal to the rotation axis 7.
performing the same previous steps, for connecting the plurality of opposing screening half-blades 8B to the screening shaft 6;
clamping the plurality of screening half-blades 8A, 8B against each other, by means of clamping screws 35 screwed into clamping holes 42 formed in the opposing half-sleeves 19 of the opposing screening half-blades 8A, 8B.

Naturally, the person skilled in the art will be able to make modifications or adaptations to this invention, but without departing from the scope of the claims set forth below.

### LIST OF REFERENCES

1. Screening bucket
2. Loading compartment
3. Unloading opening
4. Screening unit
5. Pinion
6. Screening shaft
7. Rotation axis (of the screening shaft)
8. Screening blades
8A. Screening half-blade
8B. Screening half-blade
9. Drive and transmission means
10. Positive mechanical connection
11. Box-shaped bucket body
12. Connection wall (of the half-blade)
13. Scalloping
14. Scallops
15. Lightening holes
16. Positioning and fastening means
17. Pin
18. Positioning hole
19. Half-sleeve
20. Internal half-sleeve wall (of the half-sleeve)
21. External half-sleeve wall (of the half-sleeve)
22. Through hole (of the half-sleeve)
23. Stop plate
24. First shaped profile (of the half-sleeve)
25. Hooking slots (of the half-tube)
26. Semi-circumferential end walls (of the half-sleeve)
27. Longitudinal edge walls (of the half-sleeve)
28. Hooking protrusions (of the half-blade)
29. Comb-like insert
30. Teeth
31. Second shaped profile (of the half-blade)
32. Clamping member
33. Predefined connection position
34. Circular clamp
34A. Half-clamp with smooth holes
34B. Half-clamp with threaded holes
35. Clamping screws
36. Clamping seat (on the half-sleeve)
37. Coupling recess (on the half sleeve)
38. Passage
39. Screening wall (of the screening half-blade 8A, 8B)
40. Auxiliary screening element
41. Connecting portion
42. Clamping holes
42A. Through clamping holes
42B. Threaded clamping holes
43. Wedge
44. Stop forks
45. Lightening slots
46. End half-sleeve
47. First end half-sleeve portion
48. Second end half-sleeve portion
49. Additional through hole
50. Additional pin
51. Auxiliary through hole

1-33. (canceled)

34. A screening bucket for handling debris material, particularly earth, comprising a box-shaped bucket body defining a loading compartment and an unloading opening, said screening bucket further comprising a screening unit configured to screen the debris material,
said screening unit comprising:
at least one screening shaft rotatable about a rotation axis;
at least one pinion, mounted on the at least one screening shaft, and comprising a plurality of screening blades connected to the screening shaft and extending along a radial direction orthogonal to said rotation axis;
drive and transmission means, configured to generate and transmit a rotary motion to the at least one pinion;
wherein at least one screening blade of the plurality of screening blades comprises two screening half-blades connected to the screening shaft,
wherein each screening half-blade is connected to the screening shaft approaching said screening shaft along said radial direction,
wherein each screening half-blade is connected to the screening shaft by a positive mechanical connection, and
wherein said positive mechanical connection is reversible to allow each screening half-blade to be disconnected from said screening shaft.

35. The screening bucket of claim 34, wherein the screening half-blade defines a screening wall facing away from the screening shaft and configured to screen and crush the debris material, and a connection wall facing towards the screening shaft, and wherein the two screening half-blades of a same screening blade are connected opposite to each other with respect to the screening shaft.

36. The screening bucket of claim 34, wherein the positive mechanical connection comprises positioning and fastening means, wherein the screening half-blade is connected to the screening shaft in a predefined connection position by said positioning and fastening means;
wherein the positioning and fastening means comprise:
a pin connected to a connection wall of the screening half-blade;
a positioning hole defined by the screening shaft and extending into the screening shaft along the radial direction; and
wherein the positioning hole is configured to accommodate the pin.

37. The screening bucket of claim 36, wherein said positioning and fastening means comprise a half-sleeve connected to the screening half-blade,
wherein the half-sleeve defines an internal half-sleeve wall abutting against the screening shaft, an external half-sleeve wall facing towards the connection wall of the screening half-blade, two semi-circumferential end walls and two longitudinal edge walls,
wherein the half-sleeve defines a through hole extending between the internal half-sleeve wall and the external half-sleeve wall for receiving the pin,
wherein the through hole is defined at the positioning hole, and
wherein the pin extends through the positioning hole and the through hole to connect the half-sleeve to the screening shaft.

38. The screening bucket of claim 36, wherein the positioning and fastening means comprise a stop plate positioned against the pin, wherein the connection wall of the screening half-blade defines a first shaped profile at the stop plate, and wherein the first shaped profile is configured to allow positioning of the stop plate and constrain the stop plate by shape coupling.

39. The screening bucket of claim 34, wherein the positive mechanical connection comprises positioning and fastening means, wherein the screening half-blade is connected to the screening shaft in a predefined connection position by said positioning and fastening means;
wherein the positioning and fastening means comprise a half-sleeve connected to the screening half-blade,
wherein the half-sleeve defines an internal half-sleeve wall abutting against the screening shaft, an external half-sleeve wall facing towards a connection wall of the screening half-blade, two semi-circumferential end walls and two longitudinal edge walls,
wherein the screening shaft defines a polygonal external wall, and
wherein the internal half-sleeve wall defines a polygonal counter-wall configured to form a shape coupling with the polygonal external wall of the screening shaft to allow a torque transfer between the screening shaft and the half-sleeve.

40. The screening bucket of claim 34, wherein the positive mechanical connection comprises positioning and fastening means, wherein the screening half-blade is connected to the screening shaft in a predefined connection position by said positioning and fastening means;
wherein the positioning and fastening means comprise a half-sleeve connected to the screening half-blade,
wherein the half-sleeve defines an internal half-sleeve wall abutting against the screening shaft, an external half-sleeve wall facing towards a connection wall of the screening half-blade, two semi-circumferential end walls and two longitudinal edge walls,
wherein the screening shaft defines a polygonal external wall, and
wherein the screening half-blade defines a polygonal counter-wall configured to form a shape coupling with the polygonal external wall of the screening shaft to allow a torque transfer from the screening shaft and the screening half-blade.

41. The screening bucket of claim 34, wherein the positive mechanical connection comprises positioning and fastening means, wherein the screening half-blade is connected to the screening shaft in a predefined connection position by said positioning and fastening means, and wherein the screening half-blade is connected to the positioning and fastening means by an undercut connection.

42. The screening bucket of claim 41 wherein the positioning and fastening means comprise a comb-like insert forming a plurality of teeth, and wherein the comb-like insert is connected to the screening half-blades connected to a same half-sleeve.

43. The screening bucket of claim 42, wherein a connection wall of the screening half-blade defines a second shaped profile at the comb-like insert, and wherein the second shaped profile is configured to allow positioning of the comb-like insert and constrain the comb-like insert by shape coupling between the second shaped profile and the plurality of teeth.

44. The screening bucket of claim 36, wherein the positioning and fastening means comprise a half-sleeve connected to the screening half-blade, wherein the half-sleeve defines an internal half-sleeve wall abutting against the screening shaft, an external half-sleeve wall facing towards the connection wall of the screening half-blade, two semi-circumferential end walls and two longitudinal edge walls,
wherein each pair of opposite half-sleeves and the screening shaft form a force coupling between each other,
wherein the force coupling is achieved by torque transfer facilitating means formed at the internal half-sleeve wall and/or at the screening shaft, and
wherein, optionally, the torque transfer facilitating means are roughnesses and/or ridges and/or knurls defined on the internal half-sleeve wall and/or on the screening shaft.

45. The screening bucket of claim 34, wherein the positive mechanical connection comprises positioning and fastening means, wherein the screening half-blade is connected to the screening shaft in a predefined connection position by said positioning and fastening means, wherein the positioning and fastening means comprise a clamping member configured to clamp a screening half-blade in the predefined connection position, and wherein the clamping member is a circular clamp.

46. The screening bucket of claim 45, wherein the positioning and fastening means comprise a half-sleeve connected to the screening half-blade, wherein the half-sleeve defines an internal half-sleeve wall abutting against the screening shaft, an external half-sleeve wall facing towards a connection wall of the screening half-blade, two semi-circumferential end walls and two longitudinal edge walls, and wherein the circular clamp is positioned at the two semi-circumferential end walls of the half-sleeve and is configured to clamp the two semi-circumferential end walls against the screening shaft.

47. The screening bucket of claim 36, wherein the positioning and fastening means comprise a half-sleeve connected to the screening half-blade,
wherein the half-sleeve defines an internal half-sleeve wall abutting against the screening shaft, an external half-sleeve wall facing towards the connection wall of the screening half-blade, two semi-circumferential end walls and two longitudinal edge walls,
wherein each pair of half-sleeves defines a pair of clamping holes at each semi-circumferential end wall,
wherein the half-sleeves are clampable against each other with respect to the screening shaft by clamping screws that are screwable inside the clamping holes, and, optionally,
wherein each pair of clamping holes is defined by a pair of through clamping holes defined at the semi-circumferential end wall of a half-sleeve, and by an opposite pair of threaded clamping holes defined in an opposite semi-circumferential end wall of an opposite half-sleeve, and wherein the clamping holes extend through the half-sleeve from the external half-sleeve walls to the longitudinal edge walls, or
wherein each pair of clamping holes is defined by a pair of through clamping holes defined at the semi-circumferential end wall of a half-sleeve, and by an opposite pair of further through clamping holes defined in the opposite semi-circumferential end wall of the opposite half-sleeve, and wherein two opposite half-sleeves are clamped against each other by means of bolts.

48. The screening bucket of claim 36, wherein the positioning and fastening means comprise a half-sleeve connected to the screening half-blade, wherein the half-sleeve defines an internal half-sleeve wall abutting against the screening shaft, an external half-sleeve wall facing towards the connection wall of the screening half-blade, two semi-circumferential end walls and two longitudinal edge walls, and wherein a distance between the external half-sleeve wall and the internal half-sleeve wall is maximum at the two longitudinal edge walls, and minimum in a median area, namely in a vertex area of the half-sleeve so that the external half-sleeve wall has a substantially oval shape.

49. The screening bucket of claim 36, wherein the positioning and fastening means comprise a plurality of pairs of half-sleeves connected to the screening half-blade, wherein each half-sleeve defines an internal half-sleeve wall abutting against the screening shaft, an external half-sleeve wall facing towards the connection wall of the screening half-blade, two semi-circumferential end walls and two longitudinal edge walls,
wherein the plurality of pairs of half-sleeves connected to a same screening shaft comprises at least one end half-sleeve connected to an end of the screening shaft,
wherein the end half-sleeve defines at least one through hole for a connection of the end half-sleeve to the screening shaft by at least one respective pin,
wherein the end half-sleeve defines a clamping seat interposed between two through holes, wherein the clamping seat defines a first end half-sleeve portion and a second end half-sleeve portion, wherein the first end half-sleeve portion faces towards an end of the screening shaft, and the second end half-sleeve portion faces towards an opposite direction of the end of the screening shaft, and wherein at least one through hole is defined in the first end half-sleeve portion, or at least one through hole is defined in the second end half-sleeve portion.

50. The screening bucket of claim 49, wherein the first end half-sleeve portion defines an additional through hole extending between the internal half-sleeve wall and the external half-sleeve wall,
wherein a stop plate positioned at the first end half-sleeve portion defines an auxiliary through hole at the additional through hole,
wherein the positioning and fastening means further comprise an additional pin configured to be insertable through the additional through hole and the auxiliary through hole, so as to constrain the stop plate at the first end half-sleeve portion.

51. The screening bucket of claim 34, comprising two pinions, wherein the two pinions are positioned at the unloading opening, and, optionally, wherein the screening blades have different radial extensions and are positioned on the two pinions so as to form a wavy, or “zig-zag”, passage between the two pinions.

52. A screening blade, applicable to a screening shaft of a screening bucket to screen debris material, particularly earth,
said screening bucket comprising a box-shaped bucket body defining a loading compartment and an unloading opening, said screening bucket further comprising a screening unit configured to screen the debris material
said screening unit comprising:
at least one pinion, comprising a screening shaft rotatable about a rotation axis, and a plurality of screening blades connected to the screening shaft and extending along a radial direction orthogonal to said rotation axis;
drive and transmission means configured to generate and transmit a rotary motion to at least one pinion;
wherein said screening blade comprises two screening half-blades configured to be connectable to the screening shaft,
wherein each screening half-blade is connectable to the screening shaft approaching said screening shaft along the radial direction,
wherein each screening half-blade is connectable to the screening shaft by a positive mechanical connection, and
wherein said positive mechanical connection is reversible to allow each screening half-blade to be disconnected from said screening shaft.

53. A set of screening blades, applicable to a screening shaft of a screening bucket to screen debris material, particularly earth,
said screening bucket comprising a box-shaped bucket body defining a loading compartment and an unloading opening, said screening bucket further comprising a screening unit configured to screen the debris material,
said screening unit comprising:
at least one pinion comprising a screening shaft rotatable about a rotation axis, and a plurality of screening blades connected to the screening shaft and extending along a radial direction orthogonal to said rotation axis;
drive and transmission means configured to generate and transmit a rotary motion to at least one pinion;
wherein each screening blade of said set of screening blades comprises two screening half-blades configured to be connectable to the screening shaft,
wherein each screening half-blade is connectable to the screening shaft approaching said screening shaft along the radial direction,
wherein each screening half-blade is connectable to the screening shaft by a positive mechanical connection, and
wherein said positive mechanical connection is reversible to allow each screening half-blade to be disconnected from said screening shaft.
